(19) United States
(12) Patent Application Publication
(10) Pub. No.: US 2021/0191218 A1
(43) Pub. Date: Jun. 24, 2021

(54) OPTICALLY SWITCHABLE WINDOWS FOR SELECTIVELY IMPEDING PROPAGATION OF LIGHT FROM AN ARTIFICIAL SOURCE

(71) Applicant: View, Inc., Milpitas, CA (US)

(72) Inventors: Nitesh Trikha, Pleasanton, CA (US); Robert T. Rozbicki, Saratoga, CA (US); John Gordon Halbert Mathew, Novato, CA (US); Nigel Gormly, Auckland (NZ)

(21) Appl. No.: 17/251,100

(22) PCT Filed: Jun. 11, 2019
(86) PCT No.: PCT/US2019/036571

§ 371 Date: Dec. 10, 2020

Related U.S. Application Data
(63) Continuation-in-part of application No. 16/099,424, filed on Nov. 6, 2018.
(60) Provisional application No. 62/827,674, filed on Apr. 1, 2019.
(60) Provisional application No. 62/683,572, filed on Jun. 11, 2018.
(60) Provisional application No. 62/379,163, filed on Aug. 24, 2016.
(60) Provisional application No. 62/352,508, filed on Jun. 20, 2016.
(60) Provisional application No. 62/340,936, filed on May 24, 2016.
(60) Provisional application No. 62/333,103, filed on May 6, 2016.

(51) Int. Cl. G02F 1/153; E06B 3/67; E06B 9/24; G02F 1/1506

(52) U.S. Cl. CPC G02F 1/1533; E06B 3/6722; G02F 2001/15145; G02F 1/1506; E06B 2009/2464; E06B 9/24

(57) ABSTRACT

A tintable window is described having a tintable coating, e.g., an electrochromic device coating, for regulating or blocking light transmitted through the window. In some embodiments, the window can receive, transmit and/or regulate wireless communication that uses electromagnetic waves as a communication medium. In some cases, a window can receive or transmit infrared, visible, or ultraviolet wireless light fidelity (LiFi) signals. A window can be configured, in some cases selectively configured, for blocking radiation and/or signals generated by LiFi, radio frequency (RF), laser or other devices from passing through the window. Windows configured for blocking signals may be configured as a communication firewall between an interior environment and an exterior environment, or vice-versa. Networks of tintable windows can communicate via LiFi and provide a communications network through which other devices, such as personal computing devices, can be connected to the internet or a remote network.

### CROSS-REFERENCES TO RELATED APPLICATIONS

This application claims benefit of priority of U.S. Provisional Patent Application No. 62/683,572 titled “OPTICALLY SWITCHABLE WINDOWS IN LiFi SYSTEMS”, filed on Jun. 11, 2018, and of U.S. Provisional Patent Application No. 62/827,674 titled “OPTICALLY SWITCHABLE WINDOWS FOR SELECTIVELY IMPEDING PROPAGATION OF LIGHT FROM AN ARTIFICIAL SOURCE”, filed on Apr. 1, 2019 and is a continuation in part of International Patent Application No. PCT/US17/31106, filed on May 4, 2017, and titled “WINDOW ANTENNAS,” the disclosures of which are incorporated herein by reference in its entirety for all purposes. This application is also related to U.S. Provisional Patent Application No. 62/490,457, filed Apr. 26, 2017, U.S. Provisional Patent Application No. 62/506,514, filed May 15, 2017, U.S. Provisional Patent Application No. 62/507,704, filed May 17, 2017, U.S. Provisional Patent Application No. 62/523,606, filed Dec. Jun. 22, 2017, and U.S. Provisional Patent Application No. 62/607,618, filed Dec. 19, 2017 which are all titled “ELECTROCHROMIC WINDOWS WITH TRANSPARENT DISPLAY TECHNOLOGY,” and are all incorporated herein in their entireties for all purposes. This application is also related to the following: U.S. patent application Ser. No. 13/462,725, filed May 2, 2012, and titled “ELECTROCHROMIC DEVICES; U.S. patent application Ser. No. 14/951,410, filed Nov. 14, 2015, and titled “SELF CONTAINED EC IGU,” U.S. patent application Ser. No. 13/449,248, filed Apr. 17, 2012, and titled “CONTROLLER FOR OPTICALLY-SWITCHABLE WINDOWS”; U.S. patent application Ser. No. 13/449,251, filed Apr. 17, 2012, and titled “CONTROLLER FOR OPTICALLY-SWITCHABLE WINDOWS”; U.S. patent application Ser. No. 15/334,835, filed Oct. 26, 2016, and titled “CONTROLLERS FOR OPTICALLY-SWITCHABLE DEVICES”; International Patent Application No. PCT/US17/20805, filed Mar. 3, 2017, and titled “METHOD OF COMMISSIONING ELECTROCHROMIC WINDOWS”; International Patent application No. PCT/US18/29460, filed May 25, 2018, and titled “TINTABLE WINDOW SYSTEM FOR BUILDING SERVICES”; U.S. patent application Ser. No. 15/334,832, filed Oct. 26, 2016, and titled “CONTROLLERS FOR OPTICALLY-SWITCHABLE DEVICES”; International Patent Application No. PCT/US17/62634, filed on Nov. 23, 2016, and titled “AUTOMATED COMMISSIONING OF CONTROLLERS IN A WINDOW NETWORK”; International Patent Application No. PCT/US17/31106, titled “WINDOW ANTENNAS,” and filed May 4, 2017; International Patent Application No. PCT/US18/29476, filed Apr. 25, 2018, and titled “DISPLAYS FOR TINTABLE WINDOWS”; International Patent Application No. PCT/US17/31106, titled “WINDOW ANTENNAS; U.S. patent application Ser. No. 15/287,646, titled “MULTI-SENSOR” and filed Oct. 6, 2016; U.S. patent application Ser. No. 14/423,085, filed Feb. 20, 2015 and titled “PHOTONIC-POWERED EC DEVICES”. Each of these related applications is also incorporated herein by reference in its entirety and for all purposes.

### FIELD

The embodiments disclosed herein relate generally to controlling wireless communications within or between buildings, the building including optically switchable windows, and more particularly to use of optically switchable windows configured to selectively impede propagation of light or other electromagnetic energy from an artificial source.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance.

Electrochromic materials may be incorporated into, for example, windows for home, commercial and other uses as thin film coatings on the window glass. The color, transmittance, absorbance, and/or reflectance of such windows may be changed by inducing a change in the electrochromic material, for example, electrochromic windows are windows that can be darkened or lightened electronically. A small voltage applied to an electrochromic device of the window will cause them to darken; reversing the voltage polarity causes them to lighten. This capability allows control of the amount of light that passes through the windows, and presents an opportunity for electrochromic windows to be used as energy-saving devices.

Optically switchable windows, sometimes referred to as “smart windows”, whether electrochromic or otherwise, have been used in buildings to control transmission of solar energy. Switchable windows may be manually or automatically tinted and cleared to reduce energy consumption, by heating, air conditioning and/or lighting systems, while maintaining occupant comfort.

### SUMMARY

One aspect of this disclosure pertains to a tintable window having (i) at least one lite, the lite(s) having a first surface facing a first environment and a second surface facing a second environment; (ii) an electrochromic device coating disposed on the first surface or the second surface of the at least one lite; (iii) one or more controllers having logic for (a) controlling a tint state of the electrochromic device coating, and (b) processing light fidelity (LiFi) signals received at the tintable window; and (iv) a receiver configured to receive wireless data and provide the wireless data to the controller, where the wireless data is transmitted via infrared, visible, and/or ultraviolet LiFi signals. In some embodiments, the receiver is further configured to receive wireless data transmitted via radio frequency (RF) signals.

In some embodiments, the tintable window has a shielding layer on at least one lite between the first surface and the second surface, where the shielding layer is configured to attenuate or block RF and/or LiFi signals from being transmitted between the first surface and the second surface. The shielding layer can, in some cases, be adjusted between a first state configured to attenuate or block RF and/or LiFi signals from being transmitted between the first surface and the second surface, and a second state that allows for RF and/or LiFi signals to be transmitted between the first surface and the second surface. In some embodiments, the controller has firewall logic configured to filter received wireless data and determine whether the shielding layer should be adjusted to the first state or the second state based on the filtered wireless data.

In some embodiments, the tintable window has a transmitter (controlled by the controller) which is configured to transmit wireless data via infrared, visible, or ultraviolet LiFi signals. The transmitter may also be configured to transmit wireless data via radio frequency (RF) signals. The tintable window may have a shielding layer on the at least one lite between the first surface and the second surface, where the shielding layer is configured to attenuate or block RF and/or LiFi signals from being transmitted between the first surface and the second surface. In some cases, the shielding layer can be adjusted between a first state configured to attenuate or block RF and/or LiFi signals from being transmitted between the first surface and the second surface, and a second state that allows for RF and/or LiFi signals to be transmitted between the first surface and the second surface. In some embodiments, the controller has firewall logic configured to filter the received wireless data, and determine whether the shielding layer should be adjusted to the first state or the second state based on the filtered wireless data. In some embodiments, the controller is configured to transmit wireless data via the transmitter, where the transmitted data includes wireless data received by the receiver. In some embodiments, the receiver is configured to receive wireless data from the first environment, and the transmitter is configured to transmit wireless data to the first environment. In some embodiments, the receiver is configured to receive wireless data from the first environment, and the transmitter is configured to transmit wireless data to the second environment.

In some embodiments, the controller is configured to adjust the tint state of the electrochromic device coating based at least in part on received wireless data. In some embodiments, the transmitter includes a transparent display on the at least one lite. In some embodiments, the transparent display is an organic light emitting diode display.

Another aspect of this disclosure pertains to a tintable window having (i) at least one lite, the at least one lite having a first surface facing a first environment, and a second surface facing a second environment; (ii) an electrochromic device coating disposed on the first surface or the second surface of the at least one lite; (iii) a transmitter configured to transmit wireless data via infrared, visible, or ultraviolet light fidelity LiFi signals; and (iv) one or more controllers having logic for (a) controlling a tint state of the electrochromic device coating, and (b) controlling the wireless data transmitted by the transmitter.

Another aspect of this disclosure pertains to a tintable window having (i) at least one lite, the at least one lite having a first surface facing a first environment, and a second surface facing a second environment; (ii) an electrochromic device coating disposed on the first surface or the second surface of the at least one lite; (iii) one or more controllers having logic for controlling a tint state of the electrochromic device coating; and (iv) a shielding layer on the at least one lite between the first surface and the second surface, where the shielding layer is configured to attenuate or block RF and/or LiFi signals from being transmitted between the first surface and the second surface.

Another aspect of this disclosure pertains to a building having (i) a plurality of tintable windows, where each window has an electrochromic device coating; (ii) a plurality of controllers configured to control the electrochromic device coatings on the tintable windows; and (iii) a network connecting the controllers. The network includes a plurality of receivers configured to receive wireless data transmitted via infrared, visible, or ultraviolet light fidelity (LiFi) signals; and a plurality of transmitters configured to transmit wireless data via infrared, visible, or ultraviolet LiFi signals.

In some embodiments, the network of connecting the controllers is a mesh network. In some embodiments, the controllers are configured to receive instructions via LiFi signals provided over the network for controlling the tintable windows. In some embodiments, the network connecting the controllers includes receivers for receiving radio frequency (RF) signals and/or transmitters for transmitting radio frequency (RF) signals.

In some embodiments, the network is configured to send and/or receive data from mobile devices within or near a building via the receivers and transmitters. The network may be connected to the internet.

In some embodiments, the network is configured to communicate to a second mesh network located in a second building via one or more LiFi transmitters facing the second building and one or more LiFi receivers facing the second building.

The network may include firewall logic configured to regulate data transmitted via LiFi signals. In some embodiments, at least one of the tintable windows has a shielding layer configured to block or attenuate radio frequency (RF) and/or LiFi signals from passing through the at least one tintable window. In some embodiments, the shielding layer on the at least one tintable window can be adjusted between a state that blocks or attenuates RF and/or LiFi signals and a state that permits RF and/or LiFi signals to pass through the at least one tintable window. Shielding layers may be configured to prevent RF and/or LiFi signals from leaving and/or entering the building.

Another aspect of this disclosure pertains to a controller for controlling electrochromic windows between an interior and an exterior of a building. The controller is configured to (i) receive infrared, visible, or ultraviolet wireless light fidelity signals having instructions for controlling an optical state of at least one electrochromic window; and (ii) control the optical state of one or more electrochromic windows based on the instructions in the received infrared, visible, or ultraviolet wireless light fidelity signals.

In some embodiments, the controller is further configured to transmit infrared, visible, or ultraviolet wireless light fidelity signals. The controller may be configured to transmit infrared, visible, or ultraviolet wireless light fidelity signals with status information for the at least one electrochromic window. The status information may include efficiency data or cycling data for the at least one electrochromic window.

In some embodiments, the controller is configured to transmit infrared, visible, or ultraviolet wireless light fidelity signals to a window controller and/or a building management system (BMS). The controller may include a diode laser configured to transmit the infrared, visible, or ultraviolet wireless light fidelity signals.

In some cases, the controller is configured to receive infrared, visible, or ultraviolet wireless light fidelity signals via a fiber optic cable. In some cases, the controller is configured to receive infrared, visible, or ultraviolet wireless light fidelity signals transmitted through free space.

In some cases, the controller is a window controller having a microcontroller configured to send information by light fidelity signals.

Another aspect of the present disclosure pertains to a system for controlling optically switchable windows on a network where each of the optically switchable windows is between an interior and an exterior of a building. The system has a first controller configured to transmit light fidelity signals having instructions for controlling the optical state of at least one optically switchable window, and a second controller configured to receive the transmitted light fidelity signals and control the optical state of the at least one optically switchable window based on the transmitted instructions.

In some cases, the light fidelity signals include visible light, infrared light, and/or near-ultraviolet light. In some embodiments, the first controller includes a light-emitting diode (LED) for transmitting the light fidelity signals. The LED may be controlled by a user to provide visible lighting in the building. In some embodiments, the LED includes a perovskite material (e.g., cesium lead bromide).

The second controller may, in some cases, have a photodetector configured to receive the transmitted light fidelity signals. In some cases, the second controller is configured to transmit additional light fidelity signals having status information for the at least one electrochromic window, and the first controller is configured to receive the additional light fidelity signals transmitted by the second controller. In some embodiments, status information to includes efficiency data or cycling data for the at least one optically switchable window. In some embodiments, the second controller is configured to transmit the additional light fidelity signals to a building management system (BMS).

In one embodiment, the present invention comprises a system that defines an interior and an exterior, the system comprising: a plurality of tintable windows disposed between the interior and the exterior, wherein each window comprises an interior facing pane and at least one exterior facing pane, and wherein at least one of the panes has an electrochromic device coating disposed thereon; and at least one controller configured to control a tint of the electrochromic device coating on at least one of the plurality of tintable windows so as to selectively form a shielding layer configured to attenuate or block transmission of infrared or visible light from an artificial or man-made source (“artificial light”) from passing through at least one of the panes of the at least one of the plurality of tintable windows. In one embodiment, the coating is disposed on the at least one exterior facing pane of the window. In one embodiment, the coating is disposed on an interior facing side of the at least one exterior facing pane. In one embodiment, the artificial light is generated by a LiFi device. In one embodiment, the artificial light is generated by a laser. In one embodiment, the system further comprises at least one detector functionally coupled to the at least one controller. The controller is configured control the tint of at least one of the plurality of tintable windows, in response to detection of the artificial light by the at least one detector.

In one embodiment, the present invention comprises: a method of controlling the passage of artificial light through a tintable window with steps comprising: controlling a tint of the tintable window with a controller to block transmission of visible or infrared light from passing through at least one of the pane of the tintable window, wherein the infrared or visible light is from an artificial source. In one embodiment, the window comprises an electrochromic coating disposed on at least one pane of the window. In one embodiment, the window is part of a building, and wherein the coating is disposed on an exterior facing pane of the window. In one embodiment, the coating is disposed on an interior facing side of the exterior facing pane. In one embodiment, the artificial light is generated by a LiFi device. In one embodiment, the artificial light is generated by a laser. In one embodiment, the method further comprises a step of detecting the presence of the artificial light with a detector and in response to detection of the artificial light by the detector controlling the tint of the window with the controller.

These and other features of the disclosure will be described in more detail below.

### BRIEF DESCRIPTION OF THE DRAWINGS

FIG. 1 shows a cross-sectional view of an electrochromic device that may be used in a tintable window

FIG. 2 shows a cross-sectional side view of a tintable window constructed as an insulated glass unit (“IGU”).

FIG. 3 depicts a window control network provided by of a window control system having one or more tintable windows.

FIGS. 4a-4c provide several arrangements for an electrochromic device coating and an electromagnetic shielding layer within an IGU.

FIG. 5 depicts two shielding stacks that may be used in tintable windows to provide electromagnetic shielding.

FIG. 6 depicts shielding stacks having two electroconductive layers and having three electroconductive layers, respectively.

FIG. 7 depicts a shielding film that may be mounted onto the surface of a lite to provide electromagnetic shielding.

FIG. 8 depicts tintable windows configured with LiFi transmitters and/or receivers.

FIGS. 9a-9c depict several examples of LiFi data delivery in a building.

FIG. 10 depicts a tintable window configured for wireless communication.

FIG. 11 depicts a tintable window configured for wireless communication.

FIG. 12 provides a plan view of a building where a window control system provides a communication network that may be accessed inside or near a building.

FIGS. 13a and 13b illustrate how buildings equipped for LiFi can provide a communication network in urban areas.

### DETAILED DESCRIPTION

### Introduction

The following detailed description is directed to certain embodiments or implementations for the purposes of describing the disclosed aspects. However, the teachings herein can be applied and implemented in a multitude of different ways. In the following detailed description, references are made to the accompanying drawings. Although the disclosed implementations are described in sufficient detail to enable one skilled in the art to practice the implementations, it is to be understood that these examples are not limiting; other implementations may be used and changes may be made to the disclosed implementations without departing from their spirit and scope. Furthermore, while the disclosed embodiments focus on electrochromic windows (also referred to as optically switchable windows, tintable and smart windows), the concepts disclosed herein may apply to other types of switchable optical devices including, for example, liquid crystal devices and suspended particle devices, among others. For example, a liquid crystal device or a suspended particle device, rather than an electrochromic device, could be incorporated into some or all of the disclosed implementations. Additionally, the conjunction “or” is intended herein in the inclusive sense where appropriate unless otherwise indicated; for example, the phrase “A, B or C” is intended to include the possibilities of “A,” “B,” “C,” “A and B,” “B and C,” “A and C” and “A, B, and C.”

LiFi—Light fidelity (“LiFi”) is a method of wireless communication between devices using light to transmit data. Like WiFi, LiFi transmits data over the electromagnetic spectrum, but rather than utilizing radio waves, Li-Fi uses visible, ultraviolet, and/or infrared light. One significant advantage of LiFi over radio frequency (“RF”) communication is the broad spectrum available for transmitting light communication. The visible light spectrum alone is about 1000 times larger than the entire 300 GHz of radio, microwave, and mm-wave radio spectrum. This increased bandwidth has the potential to solve many congestion issues associated with wireless communication where WiFi bands are, in many settings, becoming saturated. Another advantage to LiFi is that it can be easily contained, as LiFi signals do not pass through opaque surfaces such as most walls and ceilings, thus reducing the risk that wireless communication might be monitored for deviant purposes. By modulating the intensity of light via a LiFi transmitter, data can be coupled to light emissions. The emitted light is received at a LiFi receiver, where the light emissions are demodulated into electronic form. In cases where LiFi utilizes light having wavelengths between about 780 nm and about 375 nm, the communication is also known as visible light communication (VLC). When using VLC, light may be modulated in such a way (e.g., by rapidly pulsing light at a sufficient frequency) that the modulations are not perceptible to the human eye. Most recently it has been demonstrated that when infrared wavelengths are used, LiFi is capable of supporting communication at speeds of 40 gbps. As will be described in greater detail herein, one or more controllers on a window network may be configured to send and/or receive LiFi signals.

The following description pertains to a window control system equipped for LiFi communication transmission and/or shielding. In the window control system, windows (generally having an integrated glass unit or “IGU” structure) are configured as communication nodes and can be equipped with one or more of a LiFi receiver, a LiFi transmitter, and a LiFi shielding layer. LiFi transmitters use light emitting diodes (“LEDs”) or another light source to generate LiFi communication signals. LiFi receivers typically employ photodetectors and are configured to receive LiFi communications signals. Windows having a LiFi shield are configured such that some or all LiFi communications, and in some cases WiFi communications, are substantially attenuated or effectively blocked from passing through the window. Unless stated otherwise, “blocking” and “attenuating” are used interchangeably herein. For example, when a window is described a “blocking” LiFi signals, a LiFi signal may simply be attenuated such that a receiving device cannot, at least reliably, receive the LiFi signal. Thus even though signals may be only be attenuated, communication via LiFi may be blocked. LiFi shielding layers can be passive layers, or they may be selectively controlled to toggle between a mode that permits LiFi communication and a mode that blocks (or attenuate) LiFi communication. In some embodiments, EC device coatings can tint causing certain wavelengths of light to be attenuated or blocked. In various embodiments, the shielding layer is separate from the EC layer. In some such embodiments, the shielding layer can block or simply attenuate all or a portion of the LiFi signal as described in more detail below.

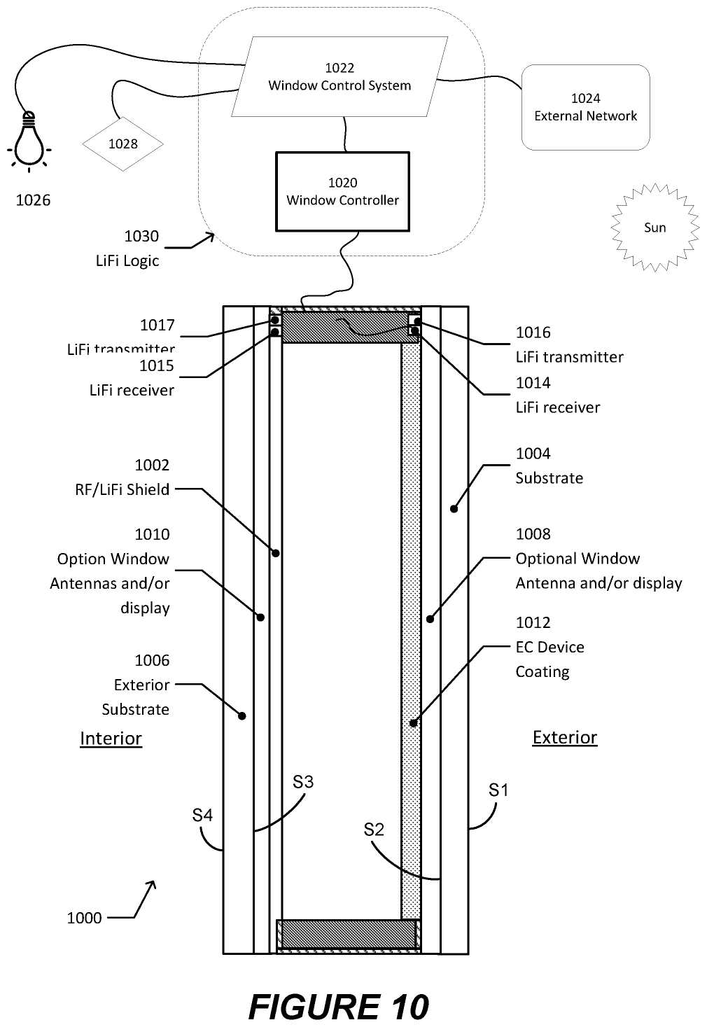

In some cases, a window network may be configured as a LiFi repeater. For example, LiFi signals received by a photodetector on one side of a window can be rebroadcast by a transmitter associated with that window. In some cases, received communication may be transmitted through a wired or optical fiber network and then rebroadcast via a different LiFi transmitter in the building. Rebroadcasting LiFi signals can increase the range of a LiFi communications network that may be limited by line of sight communication. When configured with a LiFi shielding, windows described herein can be used as firewalls that can control which communication signals can be communicated between an interior space and an exterior space. In some cases, window control systems as described herein may be used as part of a LiFi network that may be accessed by personal computing devices such as phones, laptops, and computers, and/or other building systems. LiFi networks provided by a window control system may be used to replace or may be used in conjunction with conventional WiFi networks. Window based LiFi networks are described herein, e.g., see FIGS. 10-12 and their associated descriptions.

Tintable windows—A tintable window (sometimes referred to as an optically switchable window) is a window that exhibits a controllable and reversible change in an optical property when a stimulus is applied, e.g., an applied voltage. Tintable windows can be used to control lighting conditions and the temperature within a building by regulating the transmission of solar energy and thus heat load imposed on the interior of the building. The control may be manual or automatic and may be used for maintaining occupant comfort while reducing the energy consumption of heating, air conditioning and/or lighting systems. In some cases, tintable windows may be responsive to environmental sensors and user control. In present disclosure, tintable windows are most frequently described with reference to electrochromic windows located between the interior and the exterior of a building or structure. However, this need not be the case. In some cases, tintable windows can be located within the interior of a building, e.g., between a conference room and a hallway. In some cases, tintable windows can be used in automobiles, trains, aircraft, and other vehicles. Tintable windows may operate using liquid crystal devices, suspended particle devices, or any technology known now, or later developed, that is configured to control light transmission through a window.

Electrochromic (EC) device coatings—An EC device coating (sometimes referred to as an EC device (ECD) is a coating comprising at least one layer of electrochromic material that exhibits a change from one optical state to another when an electric potential is applied across the EC device. The transition of the electrochromic layer from one optical state to another optical state can be caused by reversible ion insertion into the electrochromic material (for example, by way of intercalation) and a corresponding injection of charge-balancing electrons. In some instances, some fraction of the ions responsible for the optical transition is irreversibly bound up in the electrochromic material. In many EC devices, some or all of the irreversibly bound ions can be used to compensate for “blind charge” in the material. In some implementations, suitable ions include lithium ions (Li+) and hydrogen ions (H+) (i.e., protons). In some other implementations, other ions can be suitable. Intercalation of lithium ions, for example, into tungsten oxide (WO_{3-y} (0<y≤˜0.3)) causes the tungsten oxide to change from a transparent state to a blue state. EC device coatings as described herein are located within the viewable portion of tintable window such that the tinting of the EC device coating can be used to control the optical state of the tintable window.

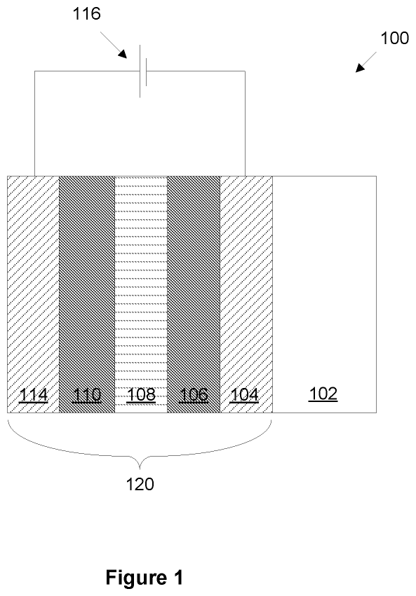

A schematic cross-section of an electrochromic device 100 in accordance with some embodiments is shown in FIG. 1. The EC device 100 includes a substrate 102, a transparent conductive layer (TCL) 104, an electrochromic layer (EC) 106 (sometimes also referred to as a cathodically coloring layer or a cathodically tinting layer), an ion conducting layer or region (IC) 108, a counter electrode layer (CE) 110 (sometimes also referred to as an anodically coloring layer or anodically tinting layer), and a second TCL 114. Collectively, elements 104, 106, 108, 110, and 114 make up an electrochromic stack 120. A voltage source 116 operable to apply an electric potential across the electrochromic stack 120 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL.

In various embodiments, the ion conductor region 108 may form from a portion of the EC layer 106 and/or from a portion of the CE layer 110. In such embodiments, the electrochromic stack 120 may be deposited to include cathodically coloring electrochromic material (the EC layer) in direct physical contact with an anodically coloring counter electrode material (the CE layer). The ion conductor region 108 (sometimes referred to as an interfacial region, or as an ion conducting substantially electronically insulating layer or region) may then form where the EC layer 106 and the CE layer 110 meet, for example through heating and/or other processing steps. Electrochromic devices fabricated without depositing a distinct ion conductor material are further discussed in U.S. patent application Ser. No. 13/462,725, filed May 2, 2012, and titled “ELECTROCHROMIC DEVICES,” which is herein incorporated by reference in its entirety. In some embodiments, an EC device coating may also include one or more additional layers such as one or more passive layers. For example, passive layers can be used to improve certain optical properties, to provide moisture or to provide scratch resistance. These or other passive layers also can serve to hermetically seal the EC stack 120. Additionally, various layers, including transparent conducting layers (such as 104 and 114), can be treated with anti-reflective or protective oxide or nitride layers.

In certain embodiments, the electrochromic device reversibly cycles between a clear state and a tinted state. In the clear state, a potential is applied to the electrochromic stack 120 such that available ions in the stack that can cause the electrochromic material 106 to be in the tinted state reside primarily in the counter electrode 110. When the potential applied to the electrochromic stack is reversed, the ions are transported across the ion conducting layer 108 to the electrochromic material 106 and cause the material to enter the tinted state.

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, transparent-opaque, etc. Further, the terms “clear” and “bleached” refer to an optically neutral state, e.g., untinted, transparent or translucent. Still further, unless specified otherwise herein, the “color” or “tint” of an electrochromic transition is not limited to any particular wavelength or range of wavelengths. As understood by those of skill in the art, the choice of appropriate electrochromic and counter electrode materials governs the relevant optical transition.

In certain embodiments, all of the materials making up electrochromic stack 120 are inorganic, solid (i.e., in the solid state), or both inorganic and solid. Because organic materials tend to degrade over time, particularly when exposed to heat and UV light as tinted building windows are, inorganic materials offer the advantage of a reliable electrochromic stack that can function for extended periods of time. Materials in the solid state also offer the advantage of not having containment and leakage issues, as materials in the liquid state often do. It should be understood that any one or more of the layers in the stack may contain some amount of organic material, but in many implementations, one or more of the layers contain little or no organic matter. The same can be said for liquids that may be present in one or more layers in small amounts. It should also be understood that solid state material may be deposited or otherwise formed by processes employing liquid components such as certain processes employing sol-gels or chemical vapor deposition.

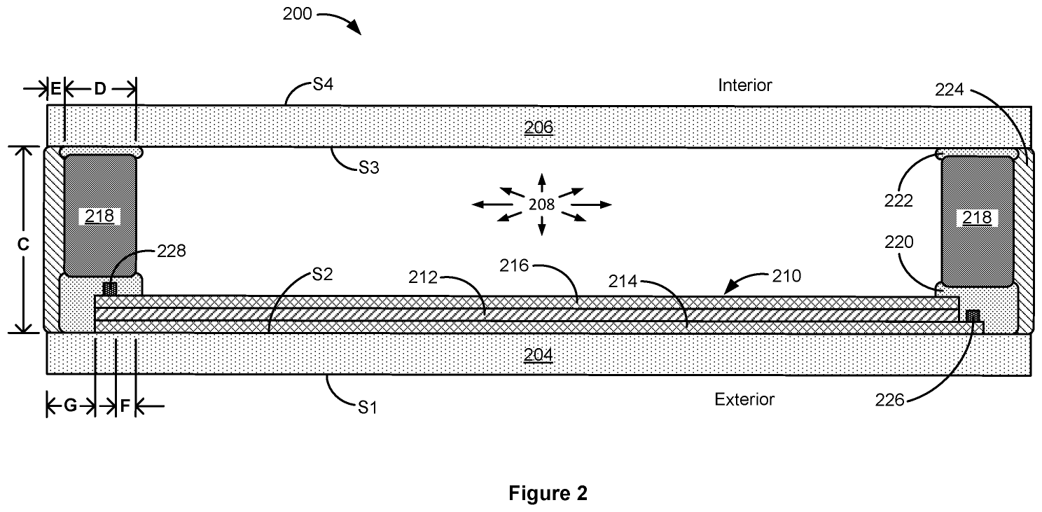

FIG. 2 shows a cross-sectional view of an example tintable window taking the form of an IGU 200 in accordance with some implementations. Generally speaking, unless stated otherwise, the terms “IGU,” “tintable window,” and “optically switchable window” are used interchangeably. This depicted convention is generally used, for example, because it is common and because it can be desirable to have IGUs serve as the fundamental constructs for holding electrochromic panes (also referred to as “lites”) when provided for installation in a building. An IGU lite or pane may be a single substrate or a multi-substrate construct, such as a laminate of two substrates. IGUs, especially those having double- or triple-pane configurations, can provide a number of advantages over single pane configurations; for example, multi-pane configurations can provide enhanced thermal insulation, noise insulation, environmental protection and/or durability when compared with single-pane configurations. A multi-pane configuration also can provide increased protection for an ECD, for example, because the electrochromic films, as well as associated layers and conductive interconnects, can be formed on an interior surface of the multi-pane IGU and be protected by an inert gas fill in the interior volume, 208, of the IGU. The inert gas fill provides at least some of the (heat) insulating function of an IGU. Electrochromic IGU's have added heat blocking capability by virtue of a tintable coating that absorbs (or reflects) heat and light.

FIG. 2 more particularly shows an example implementation of an IGU 200 that includes a first pane 204 having a first surface S1 and a second surface S2. In some implementations, the first surface S1 of the first pane 204 faces an exterior environment, such as an outdoors or outside environment. The IGU 200 also includes a second pane 206 having a first surface S3 and a second surface S4. In some implementations, the second surface S4 of the second pane 206 faces an interior environment, such as an inside environment of a home, building or vehicle, or a room or compartment within a home, building or vehicle.

In some implementations, each of the first and the second panes 204 and 206 are transparent or translucent—at least to light in the visible spectrum. For example, each of the panes 204 and 206 can be formed of a glass material and especially an architectural glass or other shatter-resistant glass material such as, for example, a silicon oxide (SOₓ)-based glass material. As a more specific example, each of the first and the second panes 204 and 206 can be a soda-lime glass substrate or float glass substrate. Such glass substrates can be composed of, for example, approximately 75% silica (SiO₂) as well as Na₂O, CaO, and several minor additives. However, each of the first and the second panes 204 and 206 can be formed of any material having suitable optical, electrical, thermal, and mechanical properties. For example, other suitable substrates that can be used as one or both of the first and the second panes 204 and 206 can include other glass materials as well as plastic, semi-plastic and thermoplastic materials (for example, poly(methyl methacrylate), polystyrene, polycarbonate, allyl diglycol carbonate, SAN (styrene acrylonitrile copolymer), poly(4-methyl-1-pentene), polyester, polyamide), or mirror materials. In some implementations, each of the first and the second panes 204 and 206 can be strengthened, for example, by tempering, heating, or chemically strengthening.

Frequently, each of the first and the second panes 204 and 206, as well as the IGU 200 as a whole, is a rectangular solid. However, in some implementations other shapes are possible and may be desired (for example, circular, elliptical, triangular, curvilinear, convex or concave shapes). In some specific implementations, a length “L” of each of the first and the second panes 204 and 206 can be in the range of approximately 20 inches (in.) to approximately 10 feet (ft.), a width “W” of each of the first and the second panes 204 and 206 can be in the range of approximately 20 in. to approximately 10 ft., and a thickness “T” of each of the first and the second panes 204 and 206 can be in the range of approximately 0.3 millimeter (mm) to approximately 10 mm (although other lengths, widths or thicknesses, both smaller and larger, are possible and may be desirable based on the needs of a particular user, manager, administrator, builder, architect or owner). In examples where thickness T of substrate 204 is less than 3 mm, typically the substrate is laminated to an additional substrate which is thicker and thus protects the thin substrate 204. Additionally, while the IGU 200 includes two panes (204 and 206), in some other implementations, an IGU can include three or more panes. Furthermore, in some implementations, one or more of the panes can itself be a laminate structure of two, three, or more layers or sub-panes.

In the illustrated example, the first and second panes 204 and 206 are spaced apart from one another by a spacer 218, which is typically a frame structure, to form an interior volume 208. In some implementations, the interior volume is filled with Argon (Ar), although in some other implementations, the interior volume 208 can be filled with another gas, such as another noble gas (for example, krypton (Kr) or xenon (Xe)), another (non-noble) gas, or a mixture of gases (for example, air). Filling the interior volume 208 with a gas such as Ar, Kr, or Xe can reduce conductive heat transfer through the IGU 200 because of the low thermal conductivity of these gases as well as improve acoustic insulation due to their increased atomic weights. In some other implementations, the interior volume 208 can be evacuated of air or other gas. Spacer 218 generally determines the height “C” of the interior volume 208; that is, the spacing between the first and the second panes 204 and 206. In FIG. 2, the thickness of the ECD, sealant 220/222 and bus bars 226/228 is not to scale; these components are generally very thin but are exaggerated here for ease of illustration only. In some implementations, the spacing “C” between the first and the second panes 204 and 206 is in the range of approximately 6 mm to approximately 30 mm. The width “D” of spacer 218 can be in the range of approximately 5 mm to approximately 25 mm (although other widths are possible and may be desirable).

Although not shown in the cross-sectional view of FIG. 2, the spacer 218 is generally a frame structure formed around all sides of the IGU 200 (for example, top, bottom, left and right sides of the IGU 200). For example, the spacer 218 can be formed of a foam or plastic material. However, in some other implementations, the spacer 218 can be formed of metal or other conductive material, for example, a metal tube or channel structure having at least 3 sides, two sides for sealing to each of the substrates and one side to support and separate the lites and as a surface on which to apply a sealant, 224. A first primary seal 220 adheres and hermetically seals spacer 218 and the second surface S2 of the first pane 204. A second primary seal 222 adheres and hermetically seals spacer 218 and the first surface S3 of the second pane 206. In some implementations, each of the primary seals 220 and 222 can be formed of an adhesive sealant such as, for example, polyisobutylene (PIB). In some implementations, the IGU 200 further includes secondary seal 224 that hermetically seals a border around the entire IGU 200 outside of spacer 218. To this end, spacer 218 can be inset from the edges of the first and the second panes 204 and 206 by a distance “E.” The distance “E” can be in the range of approximately 4 mm to approximately 8 mm (although other distances are possible and may be desirable). In some implementations, secondary seal 224 can be formed of an adhesive sealant such as, for example, a polymeric material that resists water and that adds structural support to the assembly, such as silicone, polyurethane and similar structural sealants that form a watertight seal.

In the implementation shown in FIG. 2, an ECD 210 is formed on the second surface S2 of the first pane 204. In some other implementations, ECD 210 can be formed on another suitable surface, for example, the first surface S1 of the first pane 204, the first surface S3 of the second pane 206 or the second surface S4 of the second pane 206. The ECD 210 includes an electrochromic (“EC”) stack, which itself may include one or more layers as described with reference to FIG. 1. In the illustrated example, the EC stack includes layers 212, 214 and 216.

Window Controllers—Window controllers are associated with one or more tintable windows and are configured to control a window's optical state by applying a stimulus to the window—e.g., by applying a voltage or a current to an EC device coating. Window controllers as described herein may have many sizes, formats, and locations with respect to the optically switchable windows they control. Typically, the controller may be attached to a lite of an IGU or laminate but it can also be in a frame that houses the IGU or laminate or even in a separate location. As previously mentioned, a tintable window may include one, two, three or more individual electrochromic panes (an electrochromic device on a transparent substrate). Also, an individual pane of an electrochromic window may have an electrochromic coating that has independently tintable zones. A controller as described herein can control all electrochromic coatings associated with such windows, whether the electrochromic coating is monolithic or zoned.

If not directly attached to a tintable window, IGU, or frame, the window controller is generally located in proximity to the tintable window, or at least in the same building as the window. For example, a window controller may be adjacent to the window, on the surface of one of the window's lites, within a wall next to a window, or within a frame of a self-contained window assembly. In some embodiments, the window controller is an “in situ” controller; that is, the controller is part of a window assembly, an IGU or a laminate, and may not have to be matched with the electrochromic window, and installed, in the field, e.g., the controller travels with the window as part of the assembly from the factory. The controller may be installed in the window frame of a window assembly, or be part of an IGU or laminate assembly, for example, mounted on or between panes of the IGU or on a pane of a laminate. In cases where a controller is located on the visible portion of an IGU, at least a portion of the controller may be substantially transparent. Further examples of on glass controllers are provided in U.S. patent application Ser. No. 14/951,410, filed Nov. 14, 2015, and titled “SELF CONTAINED EC IGU,” which is herein incorporated by reference in its entirety. In some embodiments, a localized controller may be provided as more than one part, with at least one part (e.g., including a memory component storing information about the associated electrochromic window) being provided as a part of the window assembly and at least one other part being separate and configured to mate with the at least one part that is part of the window assembly, IGU or laminate. In certain embodiments, a controller may be an assembly of interconnected parts that are not in a single housing, but rather spaced apart, e.g., in the secondary seal of an IGU. In other embodiments the controller is a compact unit, e.g., in a single housing or in two or more components that combine, e.g., a dock and housing assembly, that is proximate the glass, not in the viewable area, or mounted on the glass in the viewable area.

In one embodiment, the window controller is incorporated into or onto the IGU and/or the window frame prior to installation of the tintable window. In one embodiment, the controller is incorporated into or onto the IGU and/or the window frame prior to leaving the manufacturing facility. In one embodiment, the controller is incorporated into the IGU, substantially within the secondary seal. In another embodiment, the controller is incorporated into or onto the IGU, partially, substantially, or wholly within a perimeter defined by the primary seal between the sealing separator and the substrate.

Having the controller as part of an IGU and/or a window assembly, the IGU can possess logic and features of the controller that, e.g., travels with the IGU or window unit. For example, when a controller is part of the IGU assembly, in the event the characteristics of the electrochromic device(s) change over time (e.g., through degradation), a characterization function can be used, for example, to update control parameters used to drive tint state transitions. In another example, if already installed in an electrochromic window unit, the logic and features of the controller can be used to calibrate the control parameters to match the intended installation, and for example if already installed, the control parameters can be recalibrated to match the performance characteristics of the electrochromic pane(s).

In other embodiments, a controller is not pre-associated with a window, but rather a dock component, e.g., having parts generic to any electrochromic window, is associated with each window at the factory. After window installation, or otherwise in the field, a second component of the controller is combined with the dock component to complete the electrochromic window controller assembly. The dock component may include a chip which is programmed at the factory with the physical characteristics and parameters of the particular window to which the dock is attached (e.g., on the surface which will face the building's interior after installation, sometimes referred to as surface 4 or “S4”). The second component (sometimes called a “carrier,” “casing,” “housing,” or “controller”) is mated with the dock, and when powered, the second component can read the chip and configure itself to power the window according to the particular characteristics and parameters stored on the chip. In this way, the shipped window need only have its associated parameters stored on a chip, which is integral with the window, while the more sophisticated circuitry and components can be combined later (e.g., shipped separately and installed by the window manufacturer after the glazier has installed the windows, followed by commissioning by the window manufacturer). Various embodiments will be described in more detail below. In some embodiments, the chip is included in a wire or wire connector attached to the window controller. Such wires with connectors are sometimes referred to as pigtails.

As indicated hereinabove, an “IGU” includes two (or more) substantially transparent substrates, for example, two panes of glass, where at least one substrate includes an electrochromic device disposed thereon, and the panes have a separator (spacer) disposed between them. An IGU is typically hermetically sealed, having an interior region that is isolated from the ambient environment. A “window assembly” may include an IGU or for example a stand-alone laminate, and includes electrical leads for connecting the IGU's, laminates and/or one or more electrochromic devices to a voltage source, switches and the like, and may include a frame that supports the IGU or laminate. A window assembly may include a window controller as described herein, and/or components of a window controller (e.g., a dock).

As used herein, the term outboard means closer to the outside environment, while the term inboard means closer to the interior of a building. For example, in the case of an IGU having two panes, the pane located closer to the outside environment is referred to as the outboard pane or outer pane, while the pane located closer to the inside of the building is referred to as the inboard pane or inner pane. As labeled in FIG. 2, the different surfaces of the IGU may be referred to as S1, S2, S3, and S4 (assuming a two-pane IGU). S1 refers to the exterior-facing surface of the outboard lite (i.e., the surface that can be physically touched by someone standing outside). S2 refers to the interior-facing surface of the outboard lite. S3 refers to the exterior-facing surface of the inboard lite. S4 refers to the interior-facing surface of the inboard lite (i.e., the surface that can be physically touched by someone standing inside the building). In other words, the surfaces are labeled S1-S4, starting from the outermost surface of the IGU and counting inwards. In cases where an IGU includes three panes, this same convention is used (with S6 being the surface that can be physically touched by someone standing inside the building). In certain embodiments employing two panes, the electrochromic device (or other optically switchable device) is disposed on S3.

Further examples of window controllers and their features are presented in U.S. patent application Ser. No. 13/449,248, filed Apr. 17, 2012, and titled “CONTROLLER FOR OPTICALLY-SWITCHABLE WINDOWS”; U.S. patent application Ser. No. 13/449,251, filed Apr. 17, 2012, and titled “CONTROLLER FOR OPTICALLY-SWITCHABLE WINDOWS”; U.S. patent application Ser. No. 15/334,835, filed Oct. 26, 2016, and titled “CONTROLLERS FOR OPTICALLY-SWITCHABLE DEVICES”; and International Patent Application No. PCT/US17/20805, filed Mar. 3, 2017, and titled “METHOD OF COMMISSIONING ELECTROCHROMIC WINDOWS,” each of which is herein incorporated by reference in its entirety

Window Control System—When a building is outfitted with tintable windows, window controllers may be connected to one another and/or other entities via a communications network sometimes referred to as a window control network or a window network. The network and the various devices (e.g., controllers and sensors) that are connected via the network (e.g., wired or wireless power transfer and/or communication) are referred to herein as a window control system. Window control networks may provide tint instructions to window controllers, provide window information to master controllers or other network entities, and the like. Examples of window information include current tint state or other information collected by the window controller. In some cases, a window controller has one or more associated sensors including, for example, a photosensor, a temperature sensor, an occupancy sensor, and/or gas sensors that provide sensed information over the network. In some cases, information transmitted over a window communication network need not impact window control. For example, information received at a first window configured to receive a WiFi or LiFi signal may be transmitted over the communication network to a second window configured to wirelessly broadcast the information as, e.g., a WiFi or LiFi signal. A window control network need not be limited to providing information for controlling tintable windows, but may also be able to communicate information for other devices interfacing with the communications network such as HVAC systems, lighting systems, security systems, personal computing devices, and the like.

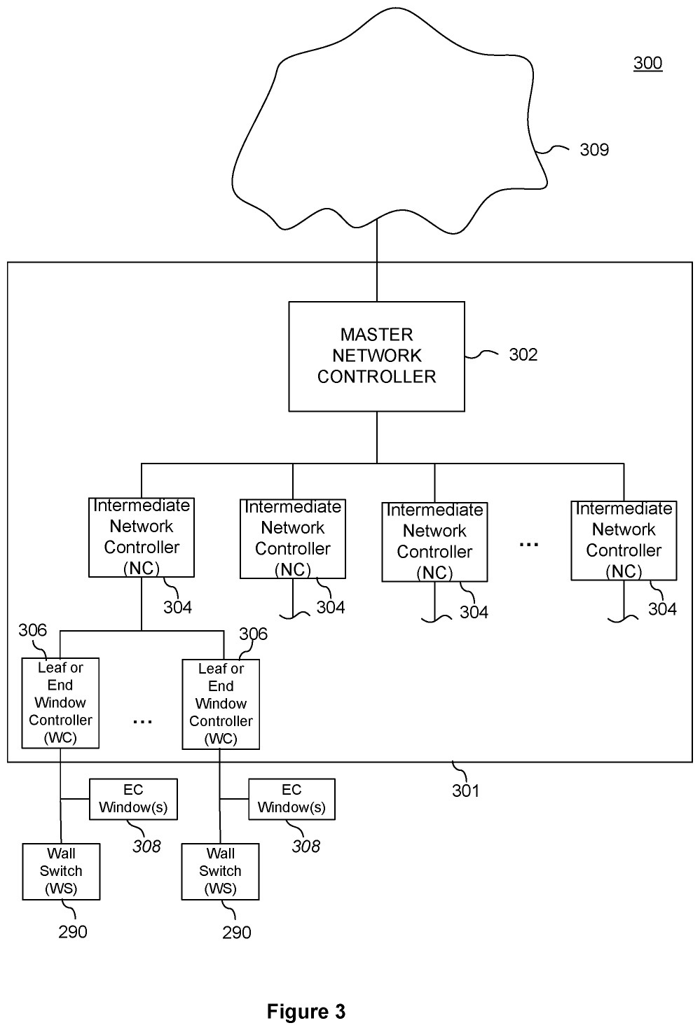

FIG. 3 provides an example of a control network 301 of a window control system 300. The network may distribute both control instructions and feedback, as well as serving as a power distribution network. A master controller 302 communicates and functions in conjunction with multiple network controllers 304, each of which network controllers is capable of addressing a plurality of window controllers 306 (sometimes referred to herein as leaf controllers) that apply a voltage or current to control the tint state of one or more optically switchable windows 308. Communications between NC's 304 WC's 306 and windows 308 may occur via wired (e.g., Ethernet) or via a wireless (e.g., WiFi or LiFi) connection. In some implementations, the master network controller 302 issues the high-level instructions (such as the final tint states of the electrochromic windows) to the NC's 304, and the NC's 304 then communicate the instructions to the corresponding WC's 308. Typically a master network controller 302 may be configured to communicate with one or more outward face networks 309. Window control network 301 can include any suitable number of distributed controllers having various capabilities or functions and need not be arranged in the hierarchical structure depicted in FIG. 3. As discussed elsewhere herein, control network 301 may also be used as a communication network between distributed controllers (e.g., 302, 304, 306) that act as communication nodes to other devices or systems (e.g., 309).

In some embodiments, outward facing network 309 is part of or connected to a building management system (BMS). A BMS is a computer-based control system that can be installed in a building to monitor and control the building's mechanical and electrical equipment. A BMS may be configured to control the operation of HVAC systems, lighting systems, power systems, elevators, fire systems, security systems, and other safety systems. BMSs are frequently used in large buildings where they function to control the environment within the building. For example, a BMS may monitor and control the lighting, temperature, carbon dioxide levels, and humidity within the building. In doing so, a BMS may control the operation of furnaces, air conditioners, blowers, vents, gas lines, water lines, and the like. To control a building's environment, the BMS may turn on and off these various devices according to rules established by, for example, a building administrator. One function of a BMS is to maintain a comfortable environment for the occupants of a building. In some implementations, a BMS can be configured not only to monitor and control building conditions, but also to optimize the synergy between various systems—for example, to conserve energy and lower building operation costs. In some implementations, a BMS can be configured with a disaster response. For example, a BMS may initiate the use of backup generators and turn off water lines and gas lines. In some cases, a BMS has a more focused application—e.g., simply controlling the HVAC system—while parallel systems such as lighting, tintable window, and/or security systems stand alone or interact with the BMS. In other cases a BMS integrates or is integrated within the functionality of a stand-alone system, for example, in one embodiment, a master controller 302 for controlling tintable windows could provide the additional functionality of a BMS.

In some embodiments, a window control network 301 may itself provide services to a building that are typically provided by a BMS. Window controllers 302, 304, and/or 306 may, in some cases, offer computational resources that can be used for other building systems. For example, controllers on the window control network may individually or collectively run software for one or more BMS applications as described previously. In some cases, window control network 301 can provide communication and/or power to other building systems. Examples of how a window control network can provide services for monitoring and/or controlling other systems in a building are further described in International Patent application No. PCT/US18/29460, filed May 25, 2018, and titled “TINTABLE WINDOW SYSTEM FOR BUILDING SERVICES,” which is herein incorporated by reference in its entirety.

In some embodiments, network 309 is a remote network. For example, network 309 may operate in the cloud or on a device remote from the building having the optically switchable windows. In some embodiments, network 309 is a network that provides information or allows control of optically switchable windows via a remote wireless device. In some cases, network 309 includes seismic event detection logic. Further examples of window control systems and their features are presented in U.S. patent application Ser. No. 15/334,832, filed Oct. 26, 2016, and titled “CONTROLLERS FOR OPTICALLY-SWITCHABLE DEVICES” and International Patent Application No. PCT/US17/62634, filed on Nov. 23, 2016, and titled “AUTOMATED COMMISSIONING OF CONTROLLERS IN A WINDOW NETWORK,” both of which are herein incorporated by reference in its entirety.

### Window Features Affecting LiFi

### LiFi and RF Shields

In some embodiments, windows are equipped as LiFi shields that block or substantially attenuate LiFi signals from passing through the window. In some embodiments, LiFi shields also are configured for blocking and/or attenuating radio frequency (“RF”) transmissions corresponding to, e.g., Bluetooth or WiFi communication. These shields are sometimes referred to as EMI (electromagnetic interference) shields. Since LiFi communication operates on a line-of-sight basis, LiFi shielding windows can be effectively be used to regulate communication entering and/or leaving a room or building. In some cases, LiFi shields block all bands of light used for LiFi communication from passing through the window, and in some cases, LiFi shields only block certain frequency ranges of light corresponding to, e.g., a LiFi communication protocol. For example, LiFi protocols sometimes utilize a first frequency band for carrying data and a different, often non-overlapping, frequency band for carrying control signals. If LiFi data is carried in a visible frequency range while LiFi control signals are carried in the infrared frequency range, a LiFi shield may selectively block only the infrared frequency range.

In some embodiments, the shielding feature of a tintable window is controllable and LiFi shielding can be toggled between on and off states. Firewall logic, operating on the window control network can be used be used to determine when to block LiFi communication by, e.g., applying an electrical potential or another driver to the LiFi shield that causes the shield to transition between blocking and non-blocking states.

In some embodiments, LiFi blocking features of a tintable window (e.g., provided by a LiFi shielding film) are passive and always enabled. This may be appropriate in certain privacy or security applications, such as secure rooms, where privacy or control of communication is always wanted. Passive shielding features are typically limited to infrared, ultraviolet, and/or specific, limited frequency ranges within the visible spectrum. A passive shielding layer cannot block all ranges of the visible spectrum—otherwise, an occupant would never be able to see through the window. Thus, “always on” LiFi shields are generally limited to situations where LiFi communication requires at least some communication to occur outside the visible portion of the EM spectrum. In some cases, a passive shield may still be effective at blocking visible light communication needed for LiFi by selectively blocking a narrow band of visible light. For example, a passive shield may block LiFi communication by blocking a band having a wavelength range less than about 50 nm, or less then about 10 nm, or less then about 5 nm, thus only resulting in a slight, if perceptible, observable difference.

LiFi blocking occurs when LiFi transmissions are absorbed or otherwise prevented from passing by one or more physical layers of a LiFi shield. In some embodiments, LiFi blocking occurs when LiFi transmissions are reflected, scattered, and/or diffracted by the shield. For example, low emissivity (“low-e”) films are commonly used in conventional windows to reflect infrared light and improving a building's insulation. In some embodiments, a LiFi shield blocks LiFi using both reflection and absorption. In some embodiments, reflecting layers can be placed between absorbing layers to increase the attenuation of certain LiFi communication frequencies.

In some embodiments, an electrochromic device coating or another tinting structure coating also acts as a LiFi shield. Thus an EC device coating may serve purposes of blocking LiFi communications while providing tinting of visible wavelengths of light. In certain embodiments, an EC layer, an IC layer, a CE layer, TCLs, or a combination of such layers (See FIG. 1: 104-110) are designed such that the one or more layers absorb radiation in a region of the spectrum where LiFi communication occurs.

In one example, LiFi communication is known to occur in the infrared region (or possibly the UV region) of the spectrum, and the first or second transparent conductive layer (104 or 114) is designed to transmit visible light but block IR light. In another example, the electrochromic layer is configured so that it always blocks radiation in the region the spectrum where LiFi transmission occurs but variably transmits radiation in the visible part of the spectrum. This, of course, assumes that LiFi transmission does not occur solely in the visible region. In yet another example, some fraction of the visible region of the spectrum is required for LiFi transmission while other regions of the visible spectrum are not. In this case, tinting may attenuate light transmission across the entire visible spectrum, while specific wavelengths used for LiFi transmission are always blocked or selectively blocked. In some embodiments, tinting of a tintable window is only effective in reducing the transmission of wavelengths that are not used for LiFi communication.

In some cases, the operation of the electrochromic device coating itself is used for controlling LiFi transmission. In such cases, LiFi transmission, or lack thereof, coincides with the optical state of the tintable window. When a potential is applied to drive tint changes to a tintable window, the absorption of LiFi signals is correspondingly impacted. An EC window in a clear or lightly tinted state may be substantially transparent to visible light and allow for some LiFi transmission while an EC window in a darker tint state may have a sufficiently low visual light transmittance (“VLT”) and attenuate LiFi signals to an amount that they can no longer be detected by a LiFi receiver. Since tintable windows do not transition to a fully opaque state, the electrochromic device coatings only attenuate, rather than completely block, LiFi transmissions in the visible range. Often, attenuation of a LiFi signal is all that is need to interrupt LiFi communication. Attenuation of LiFi bands to less than about 60%, less than about 40%, less than about 10%, or less than about 5% may be sufficient to interrupt LiFi communication in some cases. For example, such attenuation may be sufficient to prevent LiFi communications on one side of a window from interfering with LiFi communications on the other side of a window when communications on both sides of the window are using the same frequency of light. In other cases, the attenuation may simply be sufficient to reduce the LiFi signal strength beneath the level needed for reception of the LiFi signal with a LiFi receiver. Due to the non-linear relationship between transmittance and a perceived difference in window tint, the attenuation or absorbance does not have a 1:1 correlation with the perceived tint of a window. A perceived tinting effect is more closely aligned with optical density, defined as the absolute value of the common logarithm of transmittance. Corresponding to this relationship, the human eye is increasingly more perceptive to changes in a windows tint state at low transmissivity states. Thus, in some cases, sufficient attenuation of LiFi signals in the visible spectrum can still be achieved without adjusting a tintable window to the darkest tint state. For example, if an electrochromic window is configured to transition between five optical tint states (clear or TS 0, TS 1, TS 2, TS 3 and TS 4) ranging from substantially clear (TS 0) to a fully tinted state (TS 4), then even the transition between the more transparent states such as TS 0 and TS 1 or tint states TS 1 and TS 2 may be sufficient to toggle LiFi shielding between on and off states. In one embodiment, a tintable window is configured with five optical tint states TS 0, TS 1, TS 2, TS 3 and TS 4, which have visual light transmittance of approximately 82%, 58%, 40%, 7% and 1% respectively. The attenuation provided by adjusting between these tint states may, in some cases, be sufficient to toggle LiFi shielding.

Operation of the electrochromic device may be even more effective for blocking LiFi communication that uses infrared light. For example, the darker tint states (e.g., TS 3 and TS 4) from the example above may substantially block infrared LiFi transmissions reducing transmission of infrared light bands used for LiFi communication to less than about 3%, less than about 1%, or, in some cases, less than about 0.1%. Thus electrochromic device coatings may be sufficient to selectively block LiFi communication using infrared light and, in some cases, using visible light.

In some embodiments, a tintable window has a LiFi shield that is separate from the EC device coating of a tintable window. The LiFi absorbing structure is typically one or more layers that are parallel to (or substantially parallel to) the layers of the EC device coating (or other tintable layers). In certain embodiments, the LiFi shield has a surface that is coextensive with the viewable area (sometimes referred to “vision area”) of the electrochromic device coating. The coating may have the same footprint of the electrochromic device coating. However, this is not necessary so long as the LiFi shield extends to the edge of the viewable area, thus blocking incoming and outgoing light through the window.

The location of LiFi shielding layer(s) are located in a parallel or substantially parallel orientation the EC device. In some embodiments, the LiFi shield is separated from an EC device coating by a certain distance so that an electric potential applied to an EC device coating does not influence the performance of a LiFi shielding structure when, e.g., a LiFi Shield is toggled between on and off states. In cases where the shield and tintable layers are separated by air or an inert gas such as argon, the separation distance may be at least about 1 mm, or between about 5 and 50 mm. In some cases, the LiFi shield is separated from an EC device coating by a dielectric material. When separated by a dielectric material, the separation distance may be at least about 1 mm, or between about 1 and 10 mm.

In the case where a tintable window is an IGU or other multi-lite tintable window structure, there are several configurations for placement of the LiFi shield and the EC device coating. Consider, e.g., the IGU depicted in FIG. 2 with an EC device coating located on S2 of lite 204. In some embodiments, the LiFi shielding structure may be located on the same lite as the EC coating (S1). In some embodiments, the LiFi shielding structure may be located on a different lite (S3 or S4, of lite 206). This arrangement may be beneficial to provide electrical insulation when the LiFi shield comprises electrically grounded layers or layers that are held at a specific potential during a LiFi blocking mode. In other embodiments, both the LiFi shielding structure and the EC device coating may be located on the same side of the same lite (S2). In the last case, the shielding layer may be located between the substrate 204 and the EC device coating, or between the EC device coating and the interior volume of the IGU 208. As mentioned, there may be one or more dielectric layers that provide electrical insulation between the EC device coating and the LiFi shielding layer(s).

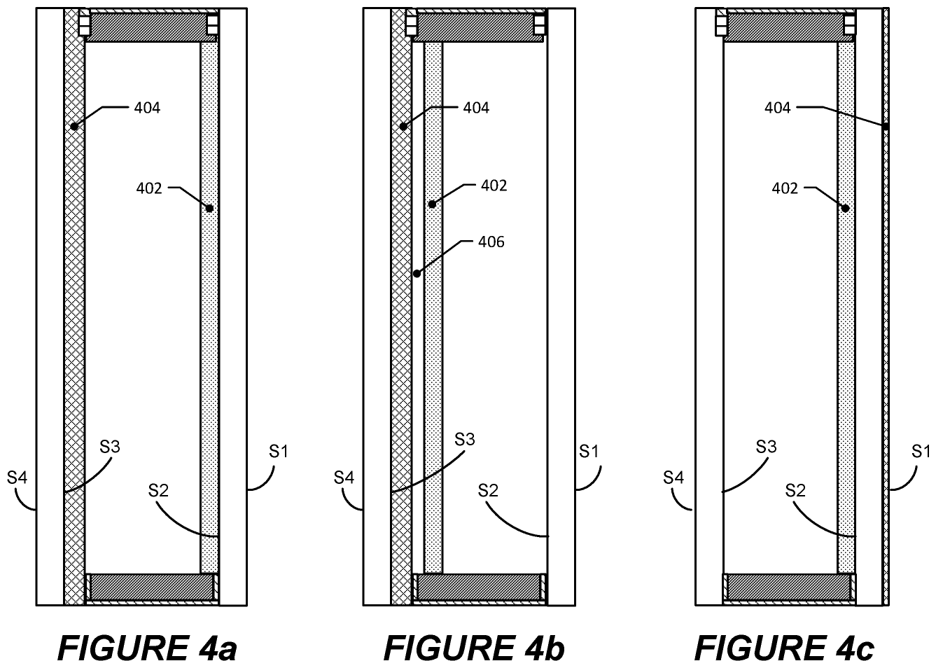

FIGS. 4a-4c depict several non-limiting arrangements for an EC device coating 402 configured to function with a LiFi and/or RF shielding layer 404 within an IGU. For clarity, some features have been omitted or are not labeled. In FIG. 4a, EC device coating 402 and LiFi and/or RF shield 404 are located on separate lights of the IGU. While EC device coating 402 and LiFi and/or RF shield 404 are depicted on the interior lite surfaces S2 and S3, these layers can also be positioned on outward facing surfaces S1 and S4. In FIG. 4b, both the EC device coating 402 and LiFi and/or RF shield 404 are located on S3 of the IGU. In some cases, e.g., when a shield layer is grounded, the EC device coating 402 and LiFi and/or RF shield 404 are electrically isolated by an intermediate dielectric layer. While depicted on surface S3, layers 402, 404, and 406 may alternatively be on S4. FIG. 4c depicts an example of the EC device coating 402 on S2 and LiFi and/or RF shield 404 as an exterior coating or film on S1 of the IGU. In some cases, in addition to blocking LiFi or RF communication, a LiFi and/or RF shield on an outward facing surface (S1 or S4) can protect the IGU. One can also appreciate that the arrangements depicted in FIGS. 4a-4ccan be inverted so that S1 faces an interior environment rather than exterior environment.

Tintable windows may also be configured to provide electromagnetic shielding for a structure or building, effectively turning a building, room, or space into a Faraday cage, provided the structure itself attenuates electromagnetic signals (e.g., the structure is made from conductive materials such as steel or aluminum or is properly grounded so as to block as a Faraday cage would otherwise). Windows configured for RF shielding may be characterized as sufficiently attenuating electromagnetic transmissions across a range of frequencies, for example between 20 MHz and 10,000 MHz. Of course, some applications may allow more limited or selective attenuation. For example, depending on the structure of the shield, one or more subranges may be excluded from attenuation. RF shields may be used to prevent electromagnetic interference (EMI), allowing for sensitive electromagnetic transmissions to be observed in the shielded space, or to block wireless communication and create private spaces in which outside devices are prevented from eavesdropping on wireless transmissions originating from within the space. For example, in some embodiments, electromagnetic radiation may be attenuated by about 10 dB to 70 dB over selected ranges or about 20 dB to 50 dB over selected ranges. While the following embodiments are described with reference to blocking RF communication, one of skill can in the art can appreciate how the dimensions of the embodiments discussed herein, particularly the thickness of various layers, may be adjusted for the purpose of blocking higher energy electromagnetic radiation, including infrared, visible, and/or ultraviolet LiFi communications. Unless stated otherwise, it is intended that all of the following embodiments are also applicable for blocking LiFi communication.

In some embodiments, tintable window are configured for RF or LiFi shielding when one or more layers of electrically conductive material are made to be coextensive with the surface of a lite to provide attenuation of electromagnetic radiation. In some cases, the attenuating effect of a window configured for shielding can be increased when electroconductive layers are grounded or held at a particular voltage to provide attenuation of electromagnetic radiation. In some cases, the one or more layers of electrically conductive material are not connected to ground or an external circuit and have a floating potential. As described herein, attenuating layers may be meshes having spacings chosen to correspond to the wavelength of radiation that is sought to be shielded. Electromagnetic shielding for window applications has previously been described in, for example, U.S. Pat. No. 5,139,850A and U.S. Pat. No. 5,147,694A.

In various embodiments, the shielding structure includes a sheet of conductive material spanning the entire area where transmission of electromagnetic radiation is blocked. For example, the structure may span the entire area of a lite. In cases where the shielding structure is made of an opaque or reflective material (in its bulk form) such as a metal, the structure may be designed to minimize attenuation of visible radiation while still strongly attenuating radiation at longer wavelengths commonly used in wireless communication. One way to minimize attenuation of visible radiation is to include anti-reflection layers next to an electroconductive layer, such as a silver layer. Typically anti-reflection layers, as described herein, will have a refractive index differing from the electroconductive layer they are proximate to. In some embodiments, the thickness and refractive index of an anti-reflection layer are chosen to produce destructive interference of light that is reflected at the layer interface and constructive interference of light that is transmitted through the layer interface. In some cases, the thickness and refractive index of an anti-reflection layer are chosen specifically to produce destructive interference at wavelengths used for LiFi communication.

In some embodiments, two or more separate metal layers are employed, along with an interlayer or anti-reflection layer between the metal layers, which together effectively attenuate transmission of electromagnetic radiation in frequencies used for wireless communication while transmitting most radiation in the visible region. Multilayer structures used for electromagnetic shielding containing at least one electroconductive layer, at least one antireflective layer, and optionally an interlayer, will be referred to herein as a shielding stack. Examples of the separation distance and thickness of such multilayer structures are presented below.

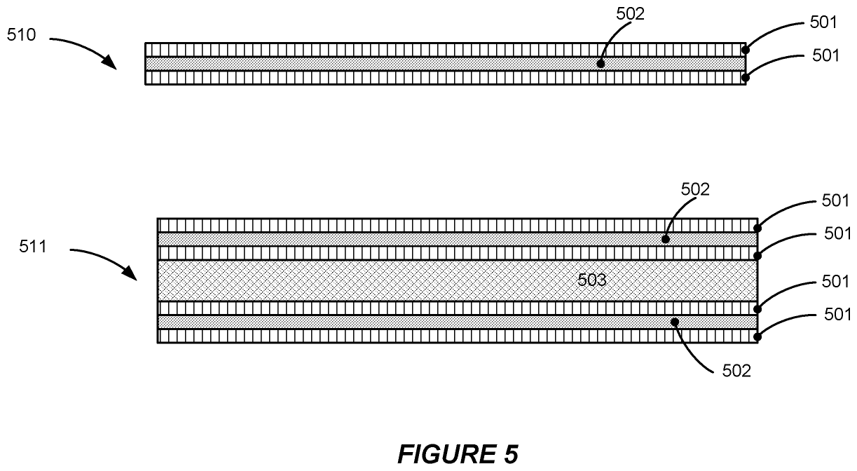

Certain examples of shielding stacks are shown in FIG. 5 as sections 510 and 511, each having at least one electroconductive layer 502 and at least two anti-reflection layers 501, straddling layer 502. In the case of shielding stack 511, an interlayer region 503 separates two electroconductive layers. A shielding stack may be placed on any surface (or interior region) of a substrate, such as S1, S2, S3, S4 of FIG. 2, or any surface of an electrochromic device, a dielectric layer, a transparent display, or even a layer containing a window antenna structure. Shielding stacks which may be used to block RF communication through windows are further described in International Patent Application No. PCT/US17/31106, titled “WINDOW ANTENNAS,” and filed May 4, 2017, which is herein incorporated in its entirety. When the shielding stack is provided on an electrochromic device or an antenna layer, the lite may include an insulating layer separating the shielding stack and the device or antenna.

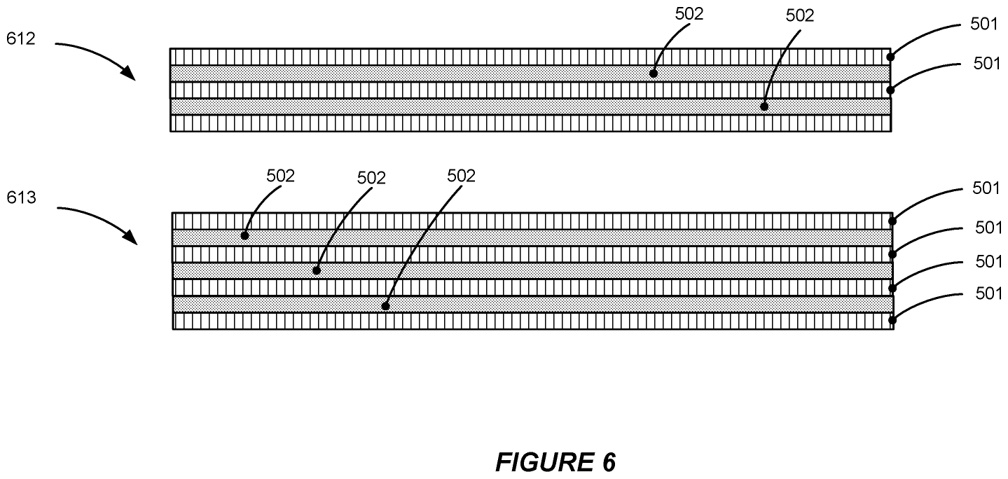

In some embodiments, a shielding stack may include two or more electroconductive layers, 502, where each electroconductive layer is sandwiched by an anti-reflection layer, 501. FIG. 6 depicts examples of a shielding stack 612 that includes two electroconductive layers 502 and a shielding stack 613 that includes three electroconductive layers 502. In some embodiments, four or more electroconductive layers may be used in a single shielding stack.

In some embodiments, the shielding stack is disposed on the mate lite (a second or additional lite in an IGU, e.g., other than the electrochromic lite) of an electrochromic IGU or as a mate lite in a laminate where one lite includes an electrochromic device coating and the other lite of the laminate has a shielding stack for selectively blocking or not blocking electromagnetic radiation, e.g., by grounding the shielding stack's metal layer(s) with a switch. This function may be incorporated into, e.g., an associated window controller. One embodiment is an electrochromic window including one lite with an electrochromic device coating and another lite with a shielding stack as described herein. In one embodiment, the shielding stack is selectively controlled to shield, or not, with a grounding function. The grounding function may be controlled by a window controller that also controls the electrochromic device's switching function. In these embodiments, where the shielding stack and the electrochromic device stack are on different substrates, the window may take the form of an IGU, a laminate, or a combination thereof, e.g., an IGU where one or both lites of the IGU is a laminate. In one example, a laminate lite of the IGU includes the shielding stack, while a non-laminate lite of the IGU includes the electrochromic device coating. In another embodiment, both lites of the IGU are laminates, where one laminate lite includes a shielding stack and the other laminate lite includes an electrochromic device coating. In yet other embodiments, a single laminate includes both an electrochromic device coating and a shielding stack. The laminate may itself be a lite of an IGU or not.

The electroconductive layer 501 may be made from any of a number of conductive materials such as silver, copper, gold, nickel, aluminum, chromium, platinum, and mixtures, intermetallics and alloys thereof. An increased thickness of an electroconductive layer results in a lower sheet resistance and typically a greater attenuating effect, however, an increased thickness also increases the material cost and may lower the visible light transmissivity.

In some embodiments, an electroconductive layer such as used in shielding stack 612 may be made of or include a “metal sandwich” construction of two or more different metal sublayers. For example, a metal layer may include a “metal sandwich” construction such as one including Cu/Ag/Cu sublayers instead of a single layer of, for example, Cu. In another example, an electroconductive layer may include a “metal sandwich” construction of NiCr/metal/NiCr, where the metal sublayer is one of the aforementioned metals.

In some embodiments, such as when a shielding stack is located adjacent to an electrochromic device, an electroconductive layer or sublayer is metal alloy. Electromigration resistance of metals can be increased through alloying. Increasing the electromigration resistance of metal layers in a metal electroconductive layer reduces the tendency of the metal to migrate into the electrochromic stack and potentially interfere with operation of the device. By using a metal alloy, the migration of metal into the electrochromic stack can be slowed and/or reduced which can improve the durability of the electrochromic device. For example, the addition of small amounts of Cu or Pd to silver can substantially increase the electromigration resistance of silver. In one embodiment, for example, a silver alloy with Cu or Pd is used in an electroconductive layer to reduce the tendency of migration of silver into the electrochromic stack to slow down or prevent such migration from interfering with normal device operation. In some cases, electroconductive sublayers may include an alloy whose oxides have low resistivity. In one example, the metal layer or sublayer may further comprise another material (e.g., Hg, Ge, Sn, Pb, As, Sb, or Bi) as compound during the preparation of the oxide to increase density and/or lower resistivity.

In some embodiments, the one or more metal sublayers of a composite electroconductive layer are transparent. Typically, a transparent metal layer is less than 10 nm thick, for example, about 5 nm thick or less. In other embodiments, the one or more metal layers of a composite conductor are opaque or not entirely transparent.

In some cases, anti-reflection layers are placed on either side of a conductive layer to enhance light transmission through coated glass substrate having the shielding stack. Typically, anti-reflection layers are a dielectric or metal oxide material. Examples of anti-reflection layers include indium tin oxide (ITO), In2O3, TiO2, Nb2O5, Ta2O5, SnO2, ZnO or Bi2O3. In certain embodiments, an anti-reflection layer is a tin oxide layer having a thickness in the range of between about 15 to 80 nm, or between about 30 to 50 nm. In general, the thickness of the anti-reflection layer may be dependent on the thickness of the conductive layer.

In certain embodiments, an anti-reflection layer is a layer of material of opposing electric susceptibility to an adjacent electroconductive metal layer. Electric susceptibility of a material refers to its ability to polarize in an applied electric field. The greater the susceptibility, the greater the ability of the material to polarize in response to the electric field. Including a layer of opposing susceptibility can change the wavelength absorption characteristics to increase the transparency of the electroconductive layer and/or shift the wavelength transmitted through the combined layers. For example, an electroconductive layer can include a high-index dielectric material layer (e.g., TiO2) of opposing susceptibility adjacent to a metal layer to increase the transparency of the metal layer. In some cases, the added layer of opposing susceptibility adjacent a metal layer can cause a not entirely transparent metal layer to be more transparent. For example, a metal layer (e.g., silver layer) having a thickness of about 5 nm to about 30 nm, or between about 10 nm and about 25 nm, or between about 15 nm and about 25 nm, may not be entirely transparent by itself. However, when located next to an anti-reflection layer of opposing susceptibility (e.g., TiO2 layer on top of the silver layer), the transmission through the combined layers is higher than the metal or dielectric layer alone.

In certain embodiments, a composite electroconductive layer may include one or more metal layers and one more color tuning sublayers also referred to as index matching sublayers. These color tuning layers are generally of a high-index, low-loss dielectric material of opposing susceptibility to the one or more metal layers. Some examples of materials that can be used in color tuning layers include silicon oxide, tin oxide, indium tin oxide, and the like. In these embodiments, the thickness and/or material used in the one or more color tuning layers changes the absorption characteristics to shift the wavelength transmitted through the combination of the material layers. For example, the thickness of the one or more color tuning layers can be selected to tune the color of light transmitted through the shielding stack. In another example, tuning layers are chosen and configured to reduce transmission of certain wavelengths (e.g., yellow) through the shielding stack. Tuning layers may be used to, e.g., block a particular band used for LiFi communication.

In one embodiment, shielding stack 510 includes a single layer of silver (or other conductive material) that has a thickness of about 15 to 60 nm. A thickness greater than about 15 nm of silver ensures that a low sheet resistance, e.g., less than 5 ohms per square, will be achieved. In certain embodiments, a single electroconductive silver layer will be between about 7 and 30 nm thick and thus allow sufficient absorption of electromagnetic radiation in communications frequencies while maintaining a sufficiently high light transmissivity. In this embodiment, a silver layer may be electrically coupled to ground either by a physical connection (e.g., a bus bar) or by capacitive coupling between the electroconductive layer and a metal frame that at least partially overlaps the electroconductive layer.

In another embodiment, shielding stack 511 includes two layers of silver (or other electroconductive material), each having a thickness of about 7 to 30 nm. It has been found that shielding panels having a reduced light reflection can be produced for a given attenuation compared to when a single, but thicker, silver layer is used. One electroconductive layer may be electrically coupled to ground either by a physical connection (e.g., a bus bar) or by capacitive coupling between the electroconductive layer and a grounded metal frame that at least partially overlaps the electroconductive layer. The second electroconductive layer may be capacitively coupled to the first grounded electroconductive layer, thus connecting the second electroconductive layer to ground. In some embodiments, both the first and second electroconductive layers are physically connected to ground. In some embodiments, both electroconductive layers have floating potentials (i.e., they are not electrically connected to ground or a source of defined potential). Most attenuation in this embodiment can be attributed to the reflection of electromagnetic radiation at the first electroconductive layer. Further attenuation occurs as a result of absorption in the interlayer region between the electroconductive layers (or their proximate antireflective layers) as the path length of incoming waves is greatly increased due to reflections between the electroconductive layers, resulting in significant absorption of radiation reflecting within the interlayer.

In another embodiment, a shielding stack such as stack 612 or stack 613 includes silver electroconductive layers that have a floating electric potential, where each silver layer has a thickness of about 10 nm-20 nm. Anti-reflection layers, which may be made of indium tin oxide, may have a thickness of about 30 nm to about 40 nm when adjacent to one silver layer and a thickness of about 75 nm to about 85 nm when interposed between two silver layers.

In some embodiments, interlayers can be made from materials that are transparent to shortwave electromagnetic radiation in the visible spectrum while absorbing frequencies having longer wavelengths that are used for communication. An interlayer may be a single layer or be a composite comprising of several material layers. If an electrochromic window is fabricated without an insulating gas layer, or if an IGU includes an additional lite disposed between lites 204 and 206, a cast-in-place resin such as polyvinyl butyral (“PVB”) or polyurethane may be used as an interlayer to laminate two panes together, each having an electroconductive layer thereon. In other embodiments, a single lite may be composed of two or more thin glass (or plastic) sheets laminated using an interlayer resin. In certain embodiments when a resin such as PVB is used, the thickness of an interlayer is in the range of about 0.25 mm to 1.5 mm.

In yet another embodiment, the outer surface of one substrate (e.g., S1 or S4), is coated with a transparent abrasion-resistant coating including an electroconductive semiconductor metal oxide layer, which may serve the purpose of a shielding stack or a portion thereof. In the depicted embodiment, the lite also includes a shielding stack 510 having a single layer of silver (or other conductive material) with a thickness of, e.g., between about 15 and 50 nm placed on one of the interior surfaces of the glass (e.g., S3 or S4), such as a surface not having an electrochromic stack or a window antenna. Optionally, an interlayer may be placed at any location between the metal oxide layer and the shielding stack to increase absorption of waves reflecting between the two electroconductive layers. In some instances, the metal oxide layer and the shielding stack are placed on opposite lites of an IGU such that there is a gap between the metal oxide layer and the shielding stack. As examples, abrasion resistant coatings may be made from metal oxides such as tin-doped indium oxide, doped tin oxide, antimony oxide, and the like. In this embodiment, the electroconductive layer and the abrasion resistant coating are electrically coupled to ground, either by a physical connection (e.g., a bus bar) or by, e.g., capacitive coupling between the electroconductive layer and a metal frame that at least partially overlaps the layer.

When a shielding stack having a single electroconductive layer (e.g., 510) is used in combination with a semiconductor metal oxide layer, or when a shielding stack having two electroconductive layers is used (e.g., 511), the spacing between electrically conducting layers required to achieve a desired attenuation of RF or LiFi transmissions may depend on the composition (e.g., glass, air, gas, or EC device layers) and thickness of the layers that lie between the two electroconductive layers.

Layers described for electromagnetic shielding may be fabricated using a variety of deposition processes including those used for fabricating electrochromic devices. In some instances, the steps used for depositing a shielding stack may be integrated into the fabrication process steps for depositing an electrochromic device. In general, a shielding stack or an abrasion-resistant coating that is a semiconductor metal oxide may be deposited by physical and/or chemical vapor techniques onto a substrate (e.g., substrate 204 or 206 of FIG. 2) at any step in the fabrication process. Individual layers of a shielding stack (501, 502, and 503) are often well suited for being deposited by a physical vapor deposition technique such as sputtering. In some cases, a silver (or other metal) layer is deposited by a technique such as cold spraying or a liquid-based process such as coating with a metal ink. In cases where a resin material such as PVB is used, the interlayer can be formed through a lamination process in which two substrates (optionally having one or more layers thereon) are joined together.

In yet another embodiment, a shielding stack for blocking RF or LiFi communication is incorporated into a flexible film, hereinafter referred to as a shielding film, which may be adhered to or otherwise mounted to a window. For example, an IGU may be configured for electromagnetic shielding by attaching a shielding film to surface S1 or S4 of an IGU lite. Alternatively, during the assembly of an IGU, a window may be configured for shielding by attaching a shielding film to surface S2 or S3 of an IGU lite. A shielding film may also be embedded in a laminate and used as a mate lite for an electrochromic IGU as described herein. For example, an IGU can be constructed so that S2 has an electrochromic film, and the mate lite for the IGU is a laminate having inside the two lites making up the laminate, a shielding film.

Shielding films may block RF, IR and/or UV signals. For example, commercially available films such as SD2500/SD2510, SD 1000/SD 1010 and DAS Shield™ films, sold by Signals Defense, of Owings Mills, Md. may be suitable for embodiments described herein.

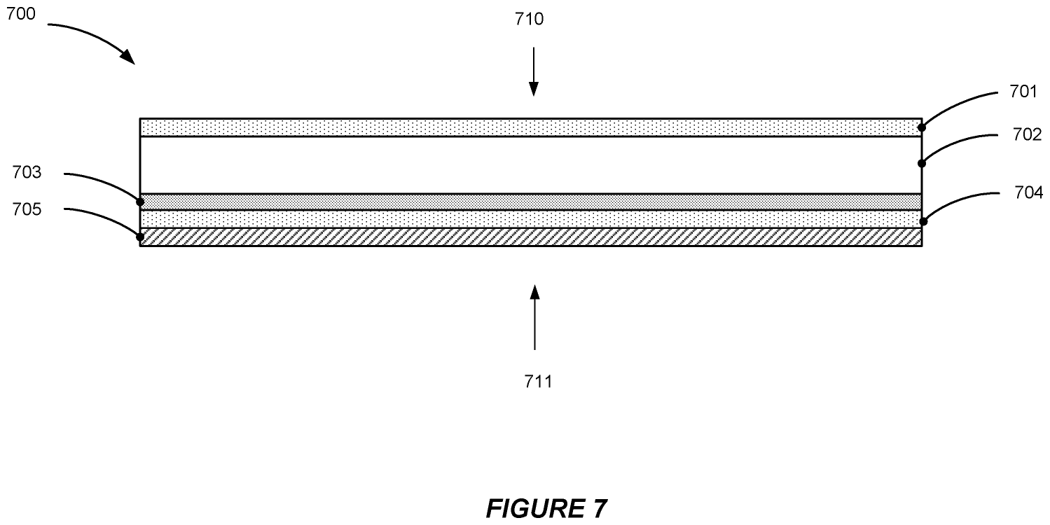

FIG. 7 depicts one embodiment of a shielding film 700 that may be mounted onto the surface of a lite to provide electromagnetic shielding. A first film layer 701 is a constraining outer layer onto which a shielding stack 702 is deposited. A laminate adhesive layer 703 is then used to bond the shielding stack to a second film layer 704 so that the shielding stack 701 is encapsulated within a flexible film (layers 701 and 704). A mounting adhesive layer 705 may then be used to bond the shielding film structure to a surface of a lite. In some embodiments, an additional protective layer may be located on surface 710. Protective layers vary upon the window environment and may include materials such as epoxy, resin, or any natural or synthetic material that provides adequate protection to of the shielding film structure. In some embodiments, the film structure 700 may differ from the illustrative embodiment depicted in FIG. 7. For example, in some embodiments a mounting adhesive layer may bond a shielding stack 702 directly to a window surface, and the laminate layer 703 and the second film layer 704 may be omitted. In certain embodiments, the total thickness of the shielding film, when mounted on a lite, is between about 25 and 1000 μm.

Many materials may be suitable for film layers 701 and 704, laminating adhesive layers 703, and mounting adhesive layers 704. Typically, materials chosen should be transparent to visible light and have sufficiently low haze, so the optical properties of a lite are not substantially diminished. This is, of course, assuming that the shielding stack is not purposed for blocking visible light communications. In certain embodiments, film layers are less than about 300 μm thick (e.g., between about 10 μm and 275 μm thick) and are made from a thermoplastic polymer resin. Examples of film materials include polyethylene terephthalate, polycarbonate, polyethylene naphthalate. One of skill in the art may select from a variety of acceptable adhesive layers and mounting adhesive layers. Different adhesives may be used depending on the thickness of a shielding stack, the placement of the film within an IGU unit, or the optical properties desired from a window configured for electromagnetic shielding. In some embodiments, a mounting adhesive layer 704 may be made from a pressure sensitive adhesive such as National Starch 80-1057 available from Ingredion Inc. Examples of other suitable adhesives include Adcote 76R36 with catalyst 9H1H, available from Rohm & Haas and Adcote 89R3 available from Rohm & Haas. When a shielding film is transported prior to installation on a glass window, a release film layer may be located on surface 711. A release film layer may protect the mounting adhesive layer 705 until the time of installation when the release film is removed.

### LiFi Receivers

LiFi receivers are used to convert a received LiFi transmission signal into an electrical signal. LiFi receivers receive LiFi signals via a photodetector or photosensors. Any photodetector may be used as a LiFi receiver, so long as it has the sensitivity and sampling rate needed to read a received LiFi signal. Suitable photodetectors include devices such as photomultipliers, CMOS image sensors, charge coupled devices (CCDs), LEDs which are reversed-biased to act as photodiodes, photodiodes (e.g., avalanche photodiodes), photovoltaic cells and the like. Generally, light from a LiFi signal is measured via a voltage or current. In some cases, a LiFi receiver may have demodulation or decoding circuitry and/or logic that extracts information from the measured voltage and/or circuitry and outputs a signal that may be interpreted by an associated controller or another electronic device. In some cases, an output signal is proved via wire to a window controller, network controller, and/or master controller. In some cases, a controller receives the raw light measurement (e.g., via a measured voltage and/or current) and the controller has demodulation or decoding circuitry and/or logic for converting the raw data into a format that can be interpreted by logic operating on the controller or the window control system.

LiFi receivers are generally placed in locations to improve the likelihood that the photodetector has an uninterrupted, direct line of sight to a LiFi transmitter providing the LiFi transmissions. A LiFi receiver may be located in a window controller (attached to or located near a corresponding window), proximate an IGU (e.g., inside the frame of the window assembly), or located a short distance away from an IGU but electrically connected to a window controller. Often, LiFi receivers may be located in an elevated position such as on the ceiling above a window to reduce the chance that an occupant might block a LiFi transmission. In some embodiments, a photodetector may be transparent, e.g., made from a transparent photovoltaic cell. In such cases, photodetectors may be placed on one or more lights of the tintable window. In some cases, a photodetector placed within the interior region of an IGU may be configured to receive LiFi signals from either side of the tintable window. In some cases, a window can be configured with multiple LiFi receivers for redundancy or to improve the reception of a LiFi signal. If a LiFi transmission is blocked from reaching one of the LiFi receivers, it may still arrive at another LiFi receiver, allowing for uninterrupted communication.

In some embodiments, a tintable window may have LiFi receivers that are configured to receive LiFi communications in different bandwidth ranges. As an illustrative example, a first LiFi receiver may be configured to receive LiFi communications in the infrared range, while a second LiFi receiver may be configured to receive LiFi communications in the visible range. In some embodiments, LiFi receivers configured for LiFi communications at different bandwidths may have different purposes. For example, a first LiFi receiver might be configured for receiving instructions for controlling the actions of a window controller (e.g., controlling the tint of the window), while a second LiFi receiver might be configured to transmitting data from or to one or more other systems making use of a LiFi communications network. In some embodiments, a LiFi receiver may be very selective to certain wavelengths of light. This may be useful in reducing the noise in a received LiFi signal or eliminating interference caused by LiFi signals transmitted at nearby wavelengths. In some cases, a LiFi receiver is configured to receive a specific bandwidth of light when one or more optical filters (e.g., high pass filters, low pass filters, or bandpass filters) are located in front of the photodetector. In some cases, a photodetector may have photovoltaic (“PV”) cells having different bandgap energies so that only light having sufficient energy (typically just below the LiFi frequency) is detected at the photodetector.

### LiFi Transmitters

LiFi transmitters are responsible for generating LiFi signals. LiFi transmitters take data provided by, e.g., a controller, the window control network, or another associated device, and convert the data into drive signals (e.g., a digital or analog signal) for controlling LiFi emissions. A drive signal specifies lighting states of the emitted LiFi signals. For example, the drive signal may specify the brightness of a LiFi signal, the wavelength(s) of a WiFi signal, and/or and shaping associated with the modulation of the LiFi signal. A LiFi drive signal may be provided by a window controller or may be generated by circuitry and/or logic integrated with or in electrical communication with the LiFi transmitter. In some cases, a window controller or another controller on the window network may have circuitry for generating the drive signal. Drive signals are then provided to a light source and/or a light modulating feature responsible for generating the LiFi signal. In some cases, a drive signal specifying a series of voltage levels is provided an LED driver that generates a modulated photonic signal corresponding to the series of voltages in the drive signal. In some cases, emitted LiFi signals are Orthogonal Frequency Dimension Multiplex (OFDM) signals which use many small-bandwidth channels rather than a single large bandwidth channel.

Light emitting diodes (LEDs) or organic light emitting diodes (OLEDs) are typically used as light sources for generating LiFi signals. To date, LEDs are the technology of choice because of speed at which they can be turned on an off. LEDs can be turned on an off at frequencies of about 1 GHz and pulsed at a sufficient brightness to transmit LiFi communication in most situations. For example, LEDs in the visible range generally need to operate at around or above 60 lux to ensure reliable LiFi communication, although the required brightness of LED may depend on a number of factors such as the ambient lighting conditions in a building and/or the sensitivity of a LiFi receiver. LiFi transmitters generally use LEDs for generating LiFi signals, however, any light source may be used so long as it can be rapidly switched between states (e.g., on, off, or intermediate states) and its output is sufficiently bright for reception by a corresponding LiFi receiver.

LiFi transmitters associated with a window can be located anywhere a LiFi receiver can be located. For example, transmitters may be part of a window controller (attached to or located near a corresponding window), proximate an IGU (e.g., inside the frame of the window assembly), or located a short distance away from an IGU but electrically connected to a window controller. As with receivers, LiFi transmitters are generally located at elevated positions such as on the ceiling or above a window to improve the likelihood of direct line-of-sight communication to a LiFi receiver.

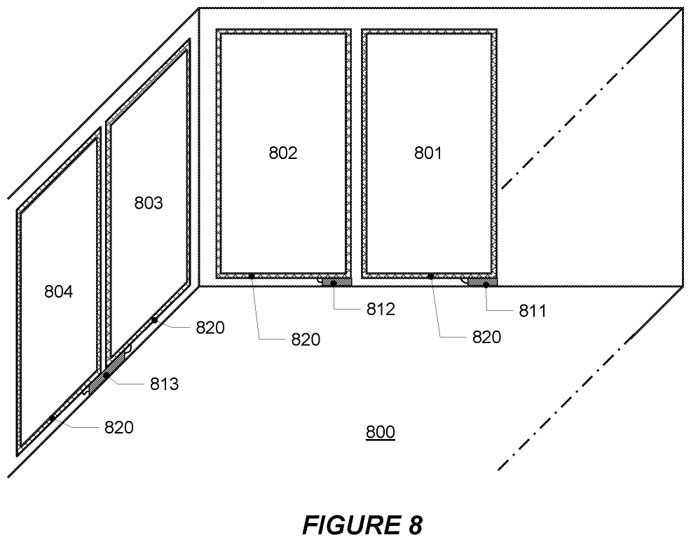

FIG. 8 depicts a room 800 with tintable windows 801-804 having LiFi transmitters and/or LiFi receivers 820 along their perimeters. A LiFi transmitter 820 may include, e.g., a strip of LEDs spanning the at least a portion of the corresponding window. Similarly, a LiFi receiver 820 may include photodetectors distributed at one or more locations around the perimeter of the window for receiving LiFi signals. When a window has LiFi transmitters and/or receivers distributed in this manner, the likelihood for uninterrupted line-of-sight communication to corresponding devices can be improved. In some cases, transmitters and/or receivers are located within the framing unit of a tintable widow or within the spacer of an IGU. Window controllers 811-813 can be configured with LiFi logic as described herein for controlling LiFi communication. In some embodiments, tintable windows have separate controllers and are configured to send and/or receive communication LiFi communication independently of one another. For example, a window controller 811 may send and receive LiFi communications via window 801 independently from LiFi communications transmitted via window 803 which is controlled by window controller 812. In some embodiments, a single window controller can be used to control the tint state of more than one tintable window. Window controller 813 may, in some cases, be configured to control LiFi transmitters and/or receivers on both window 803 and 804. For example, LiFi transmissions from windows 803 and 804 may be emitted in unison, thus further reducing the opportunities that a person or object might interrupt a LiFi communication to a device in room 800.

LEDs are well suited for generating LiFi transmissions as they can emit light at very narrowband frequencies. In cases where it is wished that the LiFi transmissions are constrained to a specific wavelength, optical filters may be placed in front of an LED or another light source. In some cases, this may be helpful in reducing interference with other LiFi communications. In some embodiments, such as when the location of a LiFi receiver is known or can be determined, a LiFi transmitter may direct LiFi transmissions in the direction of the receiver. This can be performed by, e.g., adjusting mirrors at the transmitter. When LiFi transmissions are focused in the direction of a receiver, rather than being broadcast in a wide field of view, interference to other systems can be reduced and the optical signal may be strengthened—in some cases, lessening the output requirements of a transmitter or the sensitivity of a receiver.

In some cases, a LiFi transmitter may include a transparent LED (or OLED) located in the viewable portion of a tintable window. Transparent LEDs may be located on any surface of an IGU (e.g., S1-S4 in FIG. 2). When placed in the viewable portion of an IGU, LiFi transmissions may be broadcast out both sides of the window. In some embodiments, such as when a tintable window has a LiFi shielding layer, LiFi emissions are only broadcast to either the interior side or the exterior side of the tintable window. In some embodiments, a LiFi transmitter uses a transparent display located in the viewable portion of a tintable window. Transparent displays may be, e.g., OLED or LCDs. Window displays may have other functions, such as displaying a user interface for allowing a user to control tintable windows or displaying the user interface of an operating system associated with a personal computing device. In some cases, a transparent display may generate LiFi transmissions intermittently during normal display operation. For example, an image provided by a display may be temporarily interrupted while generating a LiFi transmission. Due to the short duration and/or the intermittent nature of LiFi transmissions, LiFi transmission may be undetectable to unaided eye. In some cases, only a portion of a transparent display is used for generating LiFi emissions, e.g., in some embodiments, only the perimeter pixels of a transparent display are used. Examples of transparent displays that may be used are provided in International Patent Application No. PCT/US18/29476, filed Apr. 25, 2018, and titled “DISPLAYS FOR TINTABLE WINDOWS,” which is herein incorporated in its entirety.

In embodiments where a window is configured with a LiFi shield that can be modulated between shielding states, modulation of the LiFi shield can be used to generate LiFi signals. In this configuration, an external light source such as sunlight may provide the light for a LiFi signal. As mentioned elsewhere, dynamic LiFi shields that can be toggled between on and off states may operate by, e.g., selectively grounding or applying an electric potential to one or more transparent conductive layers spanning the viewable region of the tintable window. LiFi shields, when modulated in a similar manner as an LED or another light source, can be used to produce LiFi communications in the infrared, visible, and/or ultraviolet frequency ranges. Tintable windows configured to generate LiFi signals via a shielding layer may also have circuitry for generating a drive signal for controlling the states of a LiFi shielding layer. In some embodiments, shielding layers may be configured to transition between more than two states. For example, in addition to states that block and allow LiFi radiation, there may be intermediate states that simply attenuate LiFi transmission and/or states that selectively block some wavelengths of light but not others.

In certain embodiments, a window may use an electrowetting transparent display technology. An electrowetting display is a pixelated display where each pixel has one or more cells. Each cell can oscillate between substantially transparent and opaque optical states at a frequency of, e.g., above 30 Hz, above 60 Hz or above 120 Hz. Cells make use of surface tension and electrostatic forces to control the movement of a hydrophobic solution and a hydrophilic solution within the cell. Cells can be, e.g., white, black, cyan, magenta, yellow, red, green, blue, or some other color in their opaque state (determined by either the hydrophobic solution or the hydrophilic solution within the cell). A colored pixel may have, e.g., a cyan, magenta, yellow cells in a stacked arrangement. Perceived colors are generated by oscillating the cells of a pixel (each cell having a different color) at various frequencies. Such displays may have many thousands or millions of individually addressable cells which can produce high-resolution images and are further described in International Patent Application No. PCT/US18/29476, which as previously been incorporated by reference. In some cases, an electrowetting display can be used to generate LiFi signals by modulating the light that is transmitted through the window and/or modulating the light reflected by a transparent electrowetting display. In some embodiments, each pixel on a transparent display can be controlled synchronously to generate a LiFi signal. In other cases, a LiFi signal may be generated by controlling pixels of the display asynchronously. In some cases, both the hydrophobic solution and a hydrophilic solution within the cell are substantially transparent, but one of the solutions contains a phosphor or quantum dot (QD) material that produces a wavelength conversion of light. In other words, rather than having a clear state and an opaque state, a cell has a first substantially transparent state and a second substantially transparent state having an optical signature of the phosphor or quantum dot (QD) material. Some of the light hitting the phosphor or quantum dot (QD) material is absorbed and re-emitted at a frequency used for LiFi communication. For example, in some embodiments, quantum dots can absorb UV and visible light and emit near-infrared or infrared light. In some cases, phosphor or QD material can be included in a colored electrowetting display to generate LiFi signals

In some embodiments, a tintable window may have LiFi transmitters configured to generate LiFi communications using different wavelengths or different sets of wavelengths (e.g., in the case of OFDM signals). As an illustrative example, a first LiFi transmitter may be configured to transmit LiFi communications in the infrared range, while a second LiFi transmitter may be configured to transmit LiFi communications in the visible range. LiFi transmitters that operate at different wavelengths may be used for different purposes, e.g., one may be used for sending communication pertaining to control of windows, while another may be used to transmit data over a LiFi network.

In some cases, a window may be configured with both a LiFi transmitter and/or a LiFi receiver—enabling a tintable window to have to have two-way communication over LiFi. Transmitters and receivers may be spatially separated or may share a common housing. In some cases, transmitters share common circuitry configured to both generate drive signals and decode received LiFi transmissions. In some embodiments, both a LiFi transmitter and receiver are housed within the housing of a window controller.

When a tintable window is configured with the ability to both send and receive LiFi communication, it need not rely on other forms of wired or wireless communication to communicate with the rest of the window control system. Windows configured to send and receive wireless communications may be configured to act as LiFi repeaters that resend a received LiFi transmission. As a LiFi repeater, a tintable window may extend the coverage area of a LiFi network. In some cases, a LiFi repeater is configured to increase the strength of LiFi communication by transmitting an amplified copy of a received LiFi signal.

### LiFi Logic

Logic for controlling LiFi communications in a building (and other wireless communication such as WiFi and Bluetooth) may be implemented via the window control network. The logic may reside on window controllers, network controllers, a master controller, or on any controller in communication with the window control network. In some cases, logic for controlling LiFi communications is stored in the cloud. As described herein logic for controlling LiFi communications (hereinafter sometimes referred to as LiFi logic) is separate from logic for controlling the tint of a window, although both types of logic may be co-located on the same physical controller and/or operated using shared circuitry.

LiFi logic may be configured to send, receive, and/or block any LiFi communication protocol known know or later developed. In some cases, LiFi logic is configured for LiFi communication using one of the IEEE 802 standards (e.g., 802.11 and 802.15.7) which are herein incorporated by reference in their entireties. In some embodiments, LiFi logic may be divided into logic components used for handling control signals for the window control network (e.g., transmitting tint commands) and logic components for handling other data passed over window network.

The LiFi logic may be configured to regulate LiFi (and in some cases RF communication) by permitting some wireless transmissions but not others. When a building is equipped with windows for RF and/or LiFi shielding, windows may be configured as access points through which communication from phones, computers, and other mobile devices must pass before leaving or entering a building, or in some cases, a room. LiFi logic may be configured to permit communications originating from (or being delivered to) an authorized device or an authorized user. In this manner, windows configured to receive, transmit, and block LiFi and/or RF signals may act as a firewall, controlling which forms of wireless communication are permissible within a building. In some cases, LiFi logic may deny incoming signals from being retransmitted to their intended destination. The LiFi logic may, in some cases, be configured to communicate to devices to inform them that their request for communication has been denied. If a LiFi communication is approved, it may then be retransmitted by LiFi, (e.g., by a LiFi transmitter on the other side of a tintable window or in another part of a building), by an RF transmitter (e.g., over WiFi or Bluetooth), or to an external network.

In some cases, buildings with existing electrochromic windows may be updated so that the electrochromic windows provide dynamic LiFi shielding. For example, updated software can be deployed on one or more controllers of a window control system to adjust the tint states of the electrochromic windows based on, e.g., whether a LiFi blocking preference (e.g., in a user application for controlling optically switchable windows) is toggled on or off. In some cases, adjusting windows to tinted state may necessitate that devices, that may otherwise communicate by LiFi, transition to a Bluetooth, a WiFi, or wired connection while the window remains in a tinted state.

### LiFi Networks

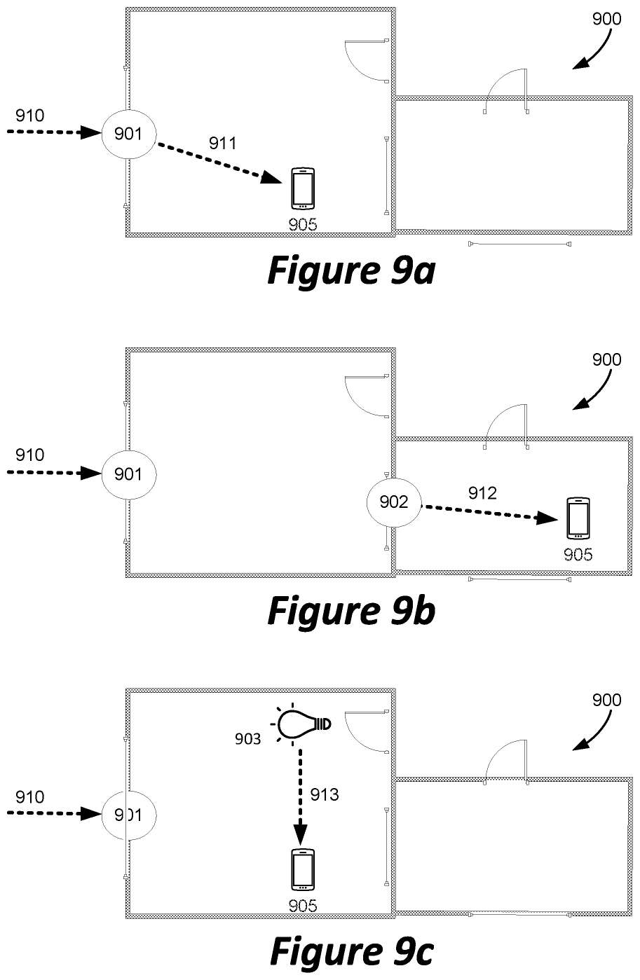

FIGS. 9a-9c depict three non-limiting examples of network operations that can be performed by tintable windows to deliver data to a device 905 equipped to receive LiFi communication in a building 900. In FIG. 9a, window 901 receives data via LiFi signal 910 and transmits the data via as a LiFi signal on the other side of the window 911 so that the data is delivered to device 905. In FIG. 9b, window 901 receives data via LiFi signal 910 and the data is transmitted through the window control network (e.g., via wire, optical fiber, WiFi, or LiFi) and transmitted via a LiFi signal 912 from another window 902. This communication path can be used if, e.g., window 901 does not have a direct line of sight to device 905. In FIG. 9c, window 901 receives data via LiFi signal 910 and the data is transmitted through the window control network (e.g., via wire, optical fiber, WiFi, or LiFi) and transmitted via a LiFi transmitter 903 connected to the window control network. LiFi transmitter may be, e.g., one or more LED bulbs that provide lighting in building 900.

FIG. 10 depicts a tintable window 1000 configured for receiving, transmitting, and regulating LiFi communication. For simplicity, various features (e.g., the layers of the EC device coating as shown in FIG. 2) have been omitted. Further, it is appreciated in the context of this application that FIG. 10 describes a plurality of embodiments corresponding to when a window only has a sub-combination of the depicted features and/or corresponding to when features are located in different positions relative to tintable window 1000. As depicted, tintable window 1000 is between an interior and exterior environment. In other embodiments, a tintable window might be between two interior spaces, e.g., between a room and a hallway. The window 1000 has an associated window controller 1020 for controlling the optical state of the window, via EC device coating 1012, and wireless communications that are received, transmitted, and/or blocked by the window. As mentioned elsewhere, window controller 1020 may be an in-situ controller or otherwise located in proximity to window 1000. In the illustrated example the window 1000 has electromagnetic shielding layer 1002 disposed proximate surface S3. The electromagnetic shield can be configured to block wireless communications such as Bluetooth, WiFi, and/or LiFi transmissions. In some embodiments, the window controller 1020 can toggle shielding layer 1002 between “on,” “off,” and/or intermediate attenuating states. On the interior side of shielding layer 1002, window 1000 has LiFi receiver 1015 and LiFi transmitter 1017 configured for receiving and transmitting LiFi communications to one or more devices or windows in an interior direction. On the exterior side of shielding layer 1002, window 1000 has LiFi receiver 1015 and LiFi transmitter 1016 facing configured to receive and transmit LiFi communications to devices and/or windows in the exterior direction. As depicted, LiFi transmitters and receivers are placed outside of the viewable region of window 1000 in the sealant area between an IGU spacer and the two lites (1004 and 1006) of the IGU. However, as mentioned elsewhere, there are many other possible locations for LiFi transmitters and receivers such that they are, e.g., part of the window assembly or located proximate an IGU. When shielding layer 1002 is not present, is not configured for blocking LiFi communication, or is toggled to an “off” state (i.e., allowing LiFi transmissions to pass through the window) a LiFi transmitter and or receiver may be located in the viewable portion of a window and may be configured to send or receive communications to both the interior and exterior environments. In some embodiments, shielding layer 1002 is configured for LiFi shielding and may be rapidly modulated between two or more states—enabling LiFi transmissions to be generated via selective blocking of light rather than selective light generation. When a window is configured to receive light from an external light source such as the sun, window controller 1020 may be configured to selectively modulate the natural or exterior lighting at one or more LiFi frequencies via control of the LiFi shield to generate LiFi transmissions in the interior environment.

In some embodiments, window 1000 may include one or more window antennas configured to receive RF communications such as cellular, Bluetooth, and WiFi communications. When a window has a shielding layer 1002 configured for blocking RF transmissions, the window may have window antennas on either side of the shielding layer (1008 and 1010). When located in the viewable region of tintable window 1000, window antennas are substantially transparent. In some cases, window antennas directed towards an interior or exterior environment are located at other locations such as on or in the framing structure of the window or within a window control unit. When a window does not have shielding layer 1002 configured to block RF transmissions, or when the shielding functionality of window antennas is turned off, a window may have antennas (e.g., antennas located on S2 or S3) that are configured to send and/or receive wireless communication to both the interior and exterior environments. Window antennas are further described in International Patent Application No. PCT/US17/31106, titled “WINDOW ANTENNAS,” which has previously been incorporated by reference into the present application.

In some embodiments, a tintable window may further include one or more transparent displays in the viewable portion of the window facing the interior environment (e.g., placed within layer 1010) or facing the exterior environment (e.g., placed within layer 1008). Transparent displays and window antennas are typically provided on separate layers of the IGU. For simplicity, here they are shown as optional layers 1008 and 1010. A transparent display may be configured to provide images and is controlled by window controller 1020. In some cases, data for a displayed image or a video signal is received via a window antenna, a LiFi receiver, or via the window control network. In some cases, a transparent display is configured to operate as a LiFi transmitter which broadcasts LiFi transmissions to an interior environment or an exterior environment. In some cases, a transparent display may replace a dedicated LiFi transmitter (1016 or 1017) or work in conjunction with a LiFi transmitter. When shielding layer 1002 is not present, is not configured for blocking LiFi communication, or is toggled to an “off” state (i.e., allowing LiFi transmissions to pass through the window), a transparent display may be located in the viewable portion of a window and configured to send or receive LiFi communications to both the interior and exterior environments. Transparent displays are further described in International Patent Application No. PCT/US18/29476, titled “DISPLAYS FOR TINTABLE WINDOWS” which has previously been incorporated.

In the illustrated example, window controller 1020 is connected to a window control system 1022 (see FIG. 2) having a control network for transmitting data and in some cases power between controllers and other devices in the system. In some cases, communication is transmitted through a wired connection such as an Ethernet or optical fiber connection. In some embodiments, window controller communicates via a window control system through a wireless connection—e.g., through WiFi or LiFi communication. When a building has multiple windows configured to send, receive, and/or block wireless communication, wireless networks may be provided throughout a building wherever windows are installed. In some cases, a window control network may include one or more LiFi transmitters 1026 or LiFi receivers 1028 that can be used to extend a LiFi network to, e.g., interior regions of a building. In some cases, LiFi transmission may be provided through a building's lighting system. A window control system may also be connected to an external network (e.g., a cellular network or the internet) and the window control network may be used as a gateway through which electronic devices in a building can connect to the external network.

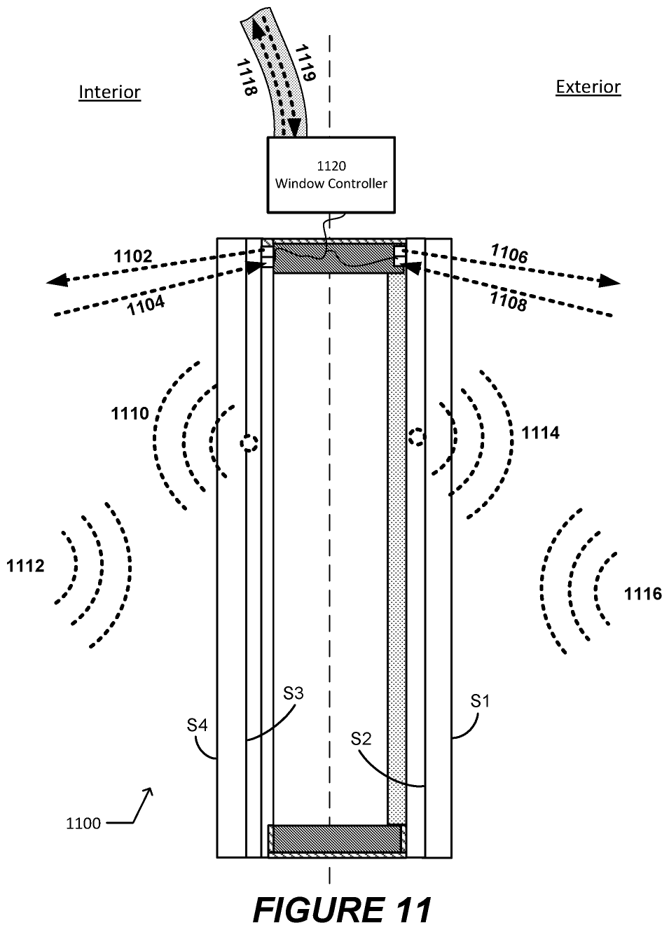

Tintable windows such as window 1000 of FIG. 10 may be used as a communication nodes or a network access point for various types of communication. FIG. 11 depicts tintable window 1100 (analogous to window 1000 of FIG. 10) which may be configured as a communication node for electric, RF, and WiFi communication.

In some cases, window 1100 is a node for LiFi-to-LiFi communication. For example, based on a received LiFi signal from an interior environment 1102 a LiFi signal may then be transmitted back into the interior environment 1104 and/or towards the windows' exterior 1106. Similarly, if a LiFi signal is received from an exterior environment 1108, then a LiFi signal may be transmitted back to the exterior environment 1106 and/or into the interior environment 1102. In some cases, based on a LiFi signal received at a window (e.g., 1108 or 1108) a window controller 1120 may be configured to send electrical signals 1118 (e.g., via Ethernet) to the window control network, or RF signals (1110 or 1114) such as WiFi or Bluetooth signals out of one or both sides of the window. When an electrical signal 1119 is received at a window controller 1120 via a wired connection, tintable window 1100 may be configured to respond by transmitting an electrical signal 1118, a LiFi signal (1102 and/or 1106), and/or an RF signal (1110 and/or 1114). Analogously, if a window receives an RF signal (1112 or 1116), the window controller may be configured to respond by transmitting an electrical signal 1118, a LiFi signal (1102 and/or 1106), and/or an RF signal (1110 and/or 1114). While signals 1118 and 1119 are described as electrical signals passing over wire, in some embodiments a window controller may connect to the window control system via LiFi communication transmitted through optical fiber.

In some cases, a window need not be configured with each of the communication interfaces depicted in FIG. 11, but may only have a subset of the depicted communication interfaces. In some cases, LiFi logic operating on the window controller 1120 or the window control system is responsible for determining whether a signal should be transmitted, and if the signal should be transmitted as an electric, RF, or LiFi signal. This may depend on various factors such as the permissions given a device or user that has sent the signal and the intended destination of the signal.

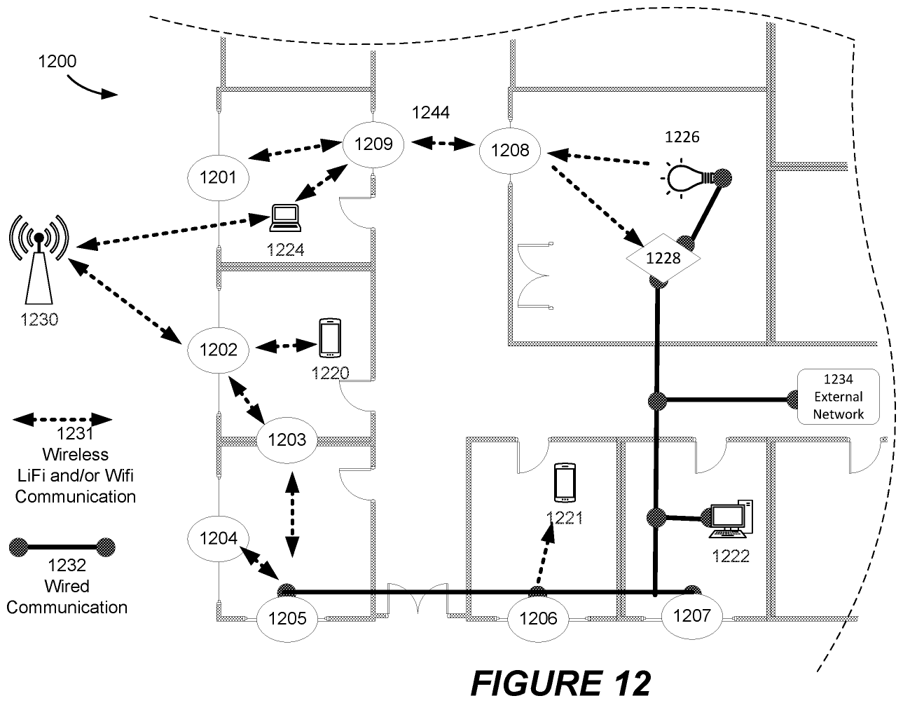

When building is outfitted with tintable windows configured for wireless communication, the window control network can serve as a network for connecting various electronic devices in a building. FIG. 12 depicts a building and illustrates how tintable windows 1201-1209 can be used to provide a building-wide network. As illustrated, windows are configured to send and receive wireless communications 1231 such as LiFi communications or RF communications. Windows may also be connected to one another by wired communication 1232. Several non-limiting illustrative examples communication pathways will now be described.

In some cases, tintable windows can regulate and/or act as a gateway for wireless communication between wireless devices in a building and wireless devices outside of a building such as wireless device 1230. Wireless device 1230 may be, e.g., cellphone tower, a LiFi enabled tintable window on an adjacent building, or any device configured for wireless communication. In some cases, a window 1201 may allow LiFi or RF communication so that communication can pass unhindered from a device outside the building 1230 to a device inside the building 1224. This may be because window 1201 is not configured for RF and/or LiFi shielding, or because the shielding function is toggled “off” to allow communication to pass through the window. In some cases, a window may act as a firewall for communication between a device exterior to a building 1230 and a mobile device 1220 within the building. For example, window 1202 may be configured for RF or LiFi shielding and require that communication be routed through a window controller associated with the window. As shown, windows on the network may communicate data between each other using LiFi or RF signals (as depicted between various sets of windows such as 1201 and 1209). In some cases, tintable windows may be connected electrically (e.g., by Ethernet) or by an optical fiber (see wired connection 1232). A wired connection may also be directly connected to a personal computer 1220 or an external network 1232 such as the internet. Thus, a computer 1222 might communicate to a wireless device 1220 through both wired and wireless connections between a plurality of tintable windows. In some cases, such as when the location of a device is unknown, a LiFi signal received by the window communication network may be rebroadcast in each room of the building by, e.g., LiFi transmitters. As can be seen by this illustration, a window control system may provide a platform through which electronic devices in a building or exterior to a building may communicate.

### LiFi as Medium of Communication Over Window Network

In some cases, a window control system equipped for LiFi can be used as a building's primary communications network, providing personal devices, building systems, IoT devices, and the like with connectivity to each other and the internet. Buildings such as the building in FIG. 12 provide a distributed network where each window configured for LiFi and/or WiFi communication acts as an access point through which devices can connect. Window control systems configured to provide a LiFi network offer a number of advantages compared to conventional RF networks. As more devices are being connected via RF communication and as devices are using larger quantities of data (for purposes such as video streaming), RF bandwidths are becoming increasingly crowded. In congested areas, such as apartment buildings, WiFi congestion often creates connectivity issues. LiFi communication has the potential to largely mitigate the issues of RF congestion since LiFi frequencies are about 1000 times more plentiful than radio frequencies and do not cause interference with RF frequencies. By having so many available frequencies, the occasions for signal interference caused by the use of shared frequencies are greatly reduced. Increased bandwidth also means that LiFi offers, in theory, a significantly higher data density than RF communication such as WiFi. Since LiFi signals are contained by walls and LiFi shields, wireless communication can be much easier to regulate. Being able to regulate the physical space of a LiFi network improves the security of the wireless network and reduces chances of possible interference. Unlike WiFi networks which may often extend out into public spaced where they can be monitored, LiFi networks are more secure because devices wishing to connect to the network or monitor LiFi communications must be within the line of sight and physical space of the LiFi network. Interference over LiFi is also reduced because walls and LiFi shields also block external LiFi communications from entering the network area. This reduction in interference provides a significant improvement over WiFi technology which is vulnerable to interference from a wide range of devices such as cordless phones, microwaves, and neighboring WiFi networks. Since LiFi networks only extend as far as an illuminated area, LiFi communication in adjacent rooms may, in some cases, occur over the same LiFi frequencies without causing interference with one another. Hardware for LiFi communication also is simpler and has the potential to be much cheaper than that needed for RF communication. While RF communication requires radio circuits, antennas, and complex receivers, LiFi modules are much simpler, in some cases resembling infrared modulation hardware found in a conventional TV remote system.

### Use Cases

One use case for installing windows configured for LiFi shielding is to regulate LiFi communications within a building. Tintable windows between a building's exterior and interior can be used to regulate communication entering and leaving the building. On a more granular scale, windows internal to a building may be used to contain wireless communication to specific rooms or areas within a building. Features for enabling LiFi shielding have been described herein, and are depicted in FIGS. 5-7. Tintable windows for LiFi shielding may have LiFi receivers or LiFi transmitters, although this is not necessary for regulating LiFi communication. In some cases, tintable windows are always “on” and configured to block LiFi communication signals. For example, a building used for private or sensitive matters may always wish to regulate wireless communications tightly and may install tintable windows with passive LiFi blocking layers that are always in an “on” state. In other embodiments, tintable windows can be toggled between “on” and “off” modes to either block or allow LiFi communication. Selecting the shielding mode of windows may involve user interaction with a wall switch or, e.g., an application used for controlling window tint states. In cases where LiFi shielding is selected by a user, the window control system need not be configured to receive or even decode LiFi communications. In some cases, tintable windows may also block RF communication. When a building has, e.g., a steel and/or concrete structure, RF communication pathways between a building's interior and exterior may already be limited to windows. In such cases, adding a passive RF shielding layer can significantly attenuate and block cellular, WiFi, or other RF communication from entering or exiting a building. Like LiFi shields, in some cases, RF shields may be toggled between “on” and “off” modes to either block or allow RF communication. While the use cases are herein are described primarily with reference to LiFi communications, it is intended the following use cases, unless stated otherwise, may also apply to RF communications. For example LiFi shields, transmitters, and receivers may be replaced or used in conjunction with RF shields, transmitters, and receivers.

In some cases, windows configured for LiFi shielding may be used to enforce a firewall system and selectively regulate what communications are permitted within in a building. Firewall logic operating on the window control system may determine whether received LiFi signals meet the predetermined rules of the firewall logic. LiFi signals may be received by tintable windows having LiFi receivers, or other LiFi receivers (e.g., third party receivers) in communication the window network. Predetermined rules of the firewall logic may be similar to those used on WiFi routers and network security systems for regulating network traffic. The rules may be configured by a building administer or IT team; for brevity, various rules commonplace in firewall system are not discussed in further here.

Referring still to FIG. 12, several illustrative examples of a LiFi Firewall in action will now described. In a first situation, a window 1202 is equipped for LiFi shielding and has a LiFi receiver facing the exterior environment (see, e.g., 1002 and 1015 in FIG. 10). Signals transmitted by an exterior device 1230 may be filtered by firewall logic to determine whether the incoming communication meets the predetermined rules. If the incoming signals are deemed acceptable by the firewall logic, the transmission may then be retransmitted to one or more devices (e.g., 1220, 1222, and 1224) within the building using LiFi, WiFi, wired connections, or a combination thereof. A tintable window having a LiFi receiver facing the interior environment may similarly be used to regulate outgoing LiFi data.

In some cases, firewall logic may be used to determine whether LiFi shielding is set to an “on” or “off” mode. In some embodiments, a window 1230 may be configured to listen to LiFi communications between devices on either side of a window (1230 and 1224). If the communication between the two devices is determined to break the rules imposed by the firewall logic, the shielding functionality may be turned on to block further communication. In other situations, a LiFi shield may first be in an “on” or blocking state and later be turned off after determining that communication from a device on either side of the window meets the rules of the firewall logic. In some embodiments, such as when LiFi communication is enforced by toggling a LiFi shield between “on” and “off” states, windows need not be configured with LiFi transmitters. This is also the case when a received LiFi signal is retransmitted via an RF transmission or a wired transmission on the other side of the window.

In some applications, a window is used to both receive and send LiFi communications. In this instance, a window must have at least one transmitter and at least one receiver. In some cases, tintable windows configured both send and receive LiFi communication can be configured as LiFi repeaters repeating a LiFi signal either on the side of the window which the LiFi signal was received or on the other side of a received LiFi signal. For example, in FIG. 12, window 1203 may repeat a LiFi signal originally transmitted by window 1202 so that the repeated signal can be delivered to window 1205.

Logic and circuitry of the LiFi transmitter, LiFi receiver, window controller, or on the window control network, can be used to produce an electronic bitstream corresponding to a received LiFi signal which can be used or modified and to generate a repeating LiFi. In some cases, an incoming LiFi signal is first processed by Firewall logic to determine whether the signal should be repeated, and in some cases, all incoming signals are repeated. In some cases, only the control signal, and not the payload of a transmitted LiFi signal, may be processed by control logic.

In some applications, a network of tintable windows may be used collectively as LiFi repeaters. For example, a first window may be configured to receive LiFi communications, which are processed and transmitted to another window where the received LiFi transmission repeated. For example, referring to FIG. 12, window 1205 may receive a signal and transmit the signal to window 1206 which then repeats the LiFi signal in a different area of the building so that the signal can be delivered to device 1221. In this example, the LiFi windows may communicate via optical fiber, wired communication, or RF communication such as WiFi. This may be useful is situations when, e.g., a signal is received on one floor of a building and then transmitted on a different floor of that same building. In some embodiments, a LiFi signal received at a first window may be encrypted and retransmitted as a LiFi signal (in some cases, between multiple intermediary windows) before it the signal is unencrypted and repeated by a second window. In some cases, an encrypted signal may be received and retransmitted between one or more windows before it arrives at the second window.

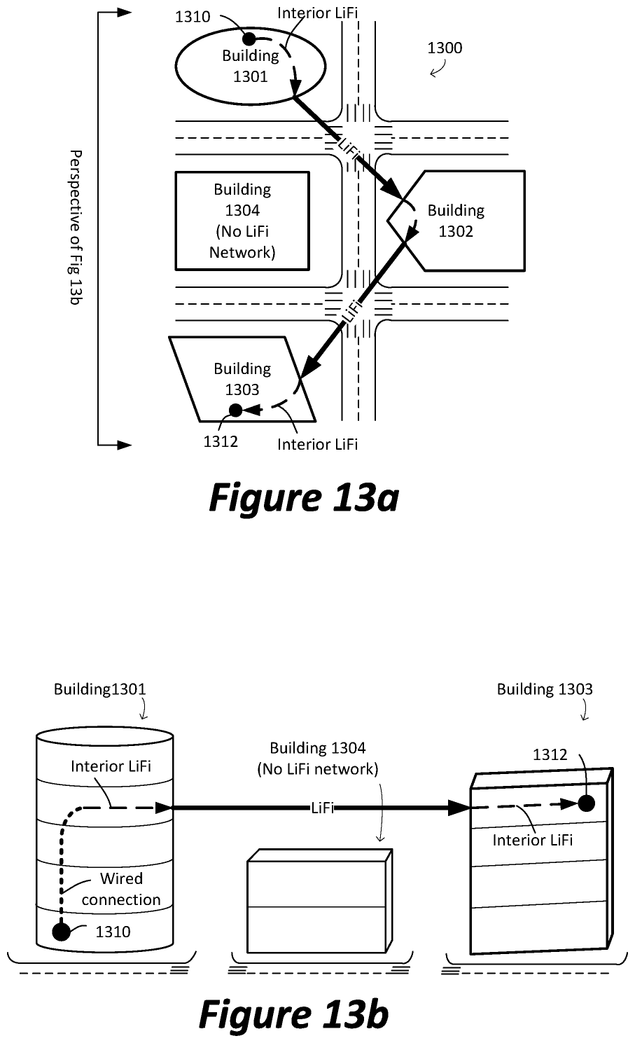

FIGS. 13a and 13b illustrate examples of how tintable windows configured for LiFi communication can be used to provide communication networks that spanning an urban area 1300. Urban area 1300 has three buildings—1301, 1302, and 1303—each configured with tintable windows for sending and receiving LiFi communications. In this example, there is also building 1304, which is not configured for LiFi communication. These two figures illustrate two possible ways in which a the LiFi networks of building 1301, 1302, and 1303 may be connected to create a larger communication network—allowing data to be transferred between device 1301 and device 1303 even though the two devices are in different buildings.

FIG. 13a depicts a plan view of urban area 1300. Building 1304 is not configured for LiFi communication and blocks what would otherwise be a line-of-sight communication pathway between building 1301 and building 1303. Due to the obstacle created by building 1304, one possible communication pathway would be to route data through building 1302 which has a line-of-sight view of both building 1301 and building 1303. In the depicted example, data from device 1310 is first transmitted to the edge (e.g., an exterior window) of building 1301 via an internal LiFi network. An externally facing LiFi transmitter in communication with the exterior window is used beam a LiFi signal to an exterior facing LiFi receiver located on building 1302. The LiFi network of building 1302 then repeats the signal by beaming it to building 1303 where the signal can be delivered to device 1312. Generally, LiFi transmissions over longer distances, such as between buildings, are in some way focused to maintain signal strength, although this is not always necessary.

FIG. 13b depicts an elevation view of buildings 1301, 1304, and 1303. In the depicted case, a direct line-of-sight is available between buildings 1301 and 1303 on the fourth floor of both buildings. For data to be transmitted from device 1310 to an exterior LiFi transmitter on the fourth floor, there needs to be communication pathways traversing between floors and pathways extending horizontally within one or more floors. While it may be possible for windows on different floors to be within sight of one another (therefore allowing for LiFi communication), this is generally not the case. Because of this, communication between floors (e.g., between tintable windows on separate floors) is generally over electric wire, optical fiber, or WiFi. In some cases, at least part of the transmission pathway within a floor may use one of these communication means. Once the data from device 1310 reaches the exterior RF transmitter, the data is beamed via LiFi to building 1303 and delivered to devise 13012. In some cases, buildings may have dedicated LiFi transmitters and/or receivers to allow for communication between them. In some cases, LiFi transmitters may generate a LiFi laser beam between buildings. In some cases, rather than using an RF transmitter or receiver associated with a tintable window, an RF transmitter or receiver may be located in the rooftop of a building. In some cases, RF transmitters and/or receivers may be incorporated into a rooftop sensor which also provides lighting data to the window control network. Rooftop sensors are further described in U.S. patent application Ser. No. 15/287,646, titled MULTI-SENSOR and filed Oct. 6, 2016, which is herein incorporated by reference in its entirety.

In some cases, a network extending between buildings (e.g., building 1301, 1302, and 1303) may be a private network, and in some cases, the network may be a public network. In some cases, the network may provide some privacy (e.g., privacy within each building) while still providing public communication services to a larger network spanning multiple buildings. Firewall logic associated with the window control system in a building may have different rules that are applied to an incoming data stream depending on the target destination of the data. For example, firewall logic associated with building 1302 in the example of FIG. 13a might not do any processing of the data originating from device 1310 once it is determined that the signal should be relayed to building 1303. In some cases, building control systems may partition their available LiFi bandwidth for different uses. For example, a first partition may be dedicated to the operation of the window control system, while a second partition may be set for devices connected to a building secure LiFi network. In some cases, another partition might be allocated for communication that is simply passing through a building's LiFi network (such as the communication depicted in FIG. 13a). In some cases, LiFi networks spanning multiple buildings may provide an improved means of accessing the internet in urban areas.

Based on the illustrated examples that have described and depicted in, e.g., FIG. 12, one can understand how LiFi communication may be used as part of the network backbone. In some cases, LiFi is not used as the “last mile” connection to connect a device to the internet, but may be used as a large communication vein in a communication network (see, e.g., LiFi communication pathway 1244 in FIG. 12). As with WiFi and other forms of wireless communication, LiFi signals or packets may be sent to confirm that information has been received or request that an transmission be repeated (e.g., if a LiFi transmission is temporarily blocked). LiFi signals may also transmit various routing and information that may determine how LiFi signals are routed through the window control network.

In some cases, a window control system configured for LiFi communication may be a self-meshing or self-healing communications network, in which the tintable window controllers recognize one another based on sensed and/or programmed inputs when the windows are first installed and turned on. Meshing may be performed by a combination of LiFi and/or WiFi communication that occurs between the tintable windows and/or controllers. One or more of the controllers, for example a master controller, may develop a map of the windows based on the self-meshing network and the information provided by the sensed and programmed inputs. In other words, the system may “self-virtualize” by creating a model of where each window is in relation to the other windows, and optionally in relation to a global position (e.g., a GPS location). In this way, installation and control of the windows is simplified, because the windows themselves do much of the work in figuring out where they are positioned and how they are oriented. There is little or no need to individually program the location and orientation of each individual window.

A wireless mesh network may be used to connect each of the windows with one another. The wireless mesh network may include radio nodes or clients (e.g., the windows/local window controllers) organized in a mesh topology. In addition to mesh clients, the mesh network may include mesh routers and gateways, for example. The mesh routers forward traffic to and from the gateways. In some embodiments, the gateways are connected with the internet. The radio nodes work with one another to create a radio network, which covers a physical area that may be referred to as the mesh cloud. The mesh cloud is distinct from “the cloud” often referred to when discussing remote data storage and processing, though in some embodiments both may be used. For instance, data generated by devices in the mesh cloud may be stored and/or processed in the cloud (i.e., remotely over the internet).

Wireless mesh architecture is effective in providing dynamic networks over a specific coverage area (the mesh cloud). Such architectures are built using peer radio or LiFi devices (nodes/clients) that do not have to be cabled to a wired port, in contrast with traditional WLAN access points, for example. Wireless mesh architectures are able to maintain signal strength by breaking long distances into a series of shorter distances. For instance, there may be a single network controller located in the basement of a building and ten local controllers located on floors 1-5 of the building. Conventional network architectures would require that the network controller be able to communicate directly to each of the ten local controllers. It may be difficult in some cases for the network controller to communicate with the local controllers, particularly the ones located farthest away on floor 5. Where a mesh network is used, each of the local tintable windows acts as an intermediate node. The intermediate nodes boost and route the signal as desired. In other words, the intermediate nodes cooperatively make signal forwarding decisions based on their knowledge of the network. Dynamic routing algorithms may be implemented in each device to allow such routing to happen. In this way, the signal only needs to be transmitted over much smaller distances (e.g., from the basement to floor 1, floor 1 to floor 2, etc.). This means that the signal transmitters can be less powerful and less costly. The mesh network may be centralized or decentralized (i.e., it may include a specific network controller that controls the local window controllers, or the network may simply be made of the local window controllers). Meshed networks of tintable windows are further described in International Patent Application No. PCT/US17/20805, filed Mar. 3, 2017, and titled “METHOD OF COMMISSIONING ELECTROCHROMIC WINDOWS,” which was perviously incorporated by reference.

In some embodiments, a light source for LiFi transmissions is used to both transmit data and deliver power. For example, light can be used to provide power for transitioning windows and/or provide power to devices in a room for purposes such as charging a phone. In some examples, communication over a window control network occurs over fiber optic cable wherein the light is used to deliver power to the tintable windows. When communication occurs via optical fiber, the communication may adhere to LiFi protocols as referenced herein, however, this is not necessary. Examples of photonic power and communication networks are further described in U.S. patent application Ser. No. 14/423,085, titled “PHOTONIC-POWERED EC DEVICES,” and filed Feb. 20, 2015, which is herein incorporated by reference in its entirety.

While tintable windows used for LiFi communication have been described with reference to communication networks in buildings, similar communication systems may be enabled for use in automobiles, trains, aircraft, and other vehicles when tintable windows are used in place of conventional windows. In some cases, windows equipped for LiFi communion may provide distinct advantages over other forms of communication that may be more easily interrupted or intercepted. For example, on clear days, LiFi may be particularly useful for battlefield applications allowing for a more secure means of communication.

Some embodiments above have described control of the tint of tintable windows to block wavelengths of signals generated by communication devices. The present invention also contemplates the use of tintable windows to block wavelengths of signals generated by other types of devices. It is known that the reflection of a signal in the form of laser beam directed at one side of a pane of window glass can be used to surveil sound signals on the other side of the pane because the sound on one side of a pane of glass causes vibrations in the glass, which causes modulations to be imposed on the reflected signal, which subsequently can be demodulated to obtain a representation of the sound. It is also known that in the instance of use a window with two or more panes of glass, the interior facing pane will vibrate more from the sound than the exterior facing pane. When a laser beam is directed at such a multi-pane window, most of, if not all, the modulations imposed on the reflected signal will therefore be caused by vibrations of the interior facing pane. Thus, when a laser beam is used to surveil communications inside of a building with multi-glass pane windows, detection of a reflection of the laser beam from an interior most glass pane is preferred.

It is also known that when surveillance is performed with a laser beam in the manner described above, a laser beam may be comprised of wavelengths that are not visible to humans, for example, infrared wavelengths. In as much as use of tintable electrochromic layers have been described above as being capable of being used to block infrared wavelengths, the present invention also contemplates that tintable electrochromic layers provided on panes of windows can also be used to substantially reduce or completely eliminate the ability to use an infrared signal directed at window to surveil sound on the other side of the window. Thus, in one embodiment, where at least one tintable electrochromic layer is provided on at least one exterior facing pane of a multi-pane window, the layer(s) substantially attenuates or completely blocks a infrared signal from passing through the layer(s) and substantially or completely prevents the signal reflected off the interior facing pane from being able to be detected. In one embodiment, it is identified that some of the signal may initially not be completely blocked, but after reflection of an interior facing pane, a reflection of the signal may be substantially or completely blocked by one or more exterior facing pane. In one embodiment, the signal comprises an infrared signal. In one embodiment, the signal is embodied in the form of a signal that is directed at windows of a building from the exterior of the building. In one embodiment, the signal comprises a laser beam. In one embodiment, the laser beam comprises an infrared laser beam. In one embodiment, control of the tint of an electrochromic layer on an interior facing side of an exterior facing window pane of a building is initiated in response to detection of artificial light located outside the building. In one embodiment, control of the tint of an electrochromic layer on an interior facing side of an exterior facing window pane of a building is initiated in response to detection of laser light located outside the building. In one embodiment, control of the tint of an electrochromic layer on an interior facing side of an exterior facing window pane of a building is initiated in response to detection of infrared light located outside the building. In one embodiment, the detection of artificial light, laser light, or infrared light is initiated by a light sensor that functionally coupled to one or more window controller that is used to effect tinting of a window in response to detection of the artificial light, laser light, or infrared light.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A tintable window, the tintable window comprising:
at least one lite, the at least one lite having a first surface facing a first environment, and a second surface facing a second environment;
an electrochromic device coating disposed on the first surface or the second surface of the at least one lite;
one or more controllers comprising logic for (a) controlling a tint state of the electrochromic device coating, and (b) processing light fidelity (LiFi) signals received at the tintable window; and
a receiver configured to receive wireless data and provide the wireless data to the controller, wherein the wireless data is transmitted via infrared, visible, and/or ultraviolet LiFi signals.

2. The tintable window of claim 1, wherein the receiver is further configured to receive wireless data transmitted via radio frequency (RF) signals.

3. The tintable window of claim 1 or 2, further comprising a shielding layer on the at least one lite between the first surface and the second surface, wherein the shielding layer is configured to attenuate or block RF and/or LiFi signals from being transmitted between the first surface and the second surface.

4. The tintable window of claim 3, wherein the shielding layer can be adjusted between a first state configured to attenuate or block RF and/or LiFi signals from being transmitted between the first surface and the second surface, and a second state that allows for RF and/or LiFi signals to be transmitted between the first surface and the second surface.

5. The tintable window of claim 4, wherein the controller further comprises firewall logic configured to filter received wireless data, and determine whether the shielding layer should be adjusted to the first state or the second state based on the filtered wireless data.

6. The tintable window of any of claims 1 through 5, further comprising a transmitter configured to transmit wireless data via infrared, visible, or ultraviolet LiFi signals, wherein the transmitter is controlled by the controller.

7. The tintable window of claim 6, wherein the transmitter is further configured to transmit wireless data via radio frequency (RF) signals.

8. The tintable window of claim 7, further comprising a shielding layer on the at least one lite between the first surface and the second surface, wherein the shielding layer is configured to attenuate or block RF and/or LiFi signals from being transmitted between the first surface and the second surface.

9. The tintable window of claim 8, wherein the shielding layer can be adjusted between a first state configured to attenuate or block RF and/or LiFi signals from being transmitted between the first surface and the second surface, and a second state that allows for RF and/or LiFi signals to be transmitted between the first surface and the second surface.

10. The tintable window of claim 9, wherein the controller further comprises firewall logic configured to filter received wireless data, and determine whether the shielding layer should be adjusted to the first state or the second state based on the filtered wireless data.

11. The tintable window of any of claims 6 through 10, wherein the controller is configured to transmit wireless data via the transmitter, wherein the transmitted data comprises wireless data received by the receiver.

12. The tintable window of any of claims 6 through 11, wherein the receiver is configured to receive wireless data from the first environment, and the transmitter is configured to transmit wireless data to the first environment.

13. The tintable window of any of claims 6 through 12, wherein the receiver is configured to receive wireless data from the first environment, and the transmitter is configured to transmit wireless data to the second environment.

14. The tintable window of any of claim 6-13, wherein the transmitter comprises a transparent display on the at least one lite.

15. The tintable window of any of claims 6 through 14, wherein the controller is configured to adjust the tint state of the electrochromic device coating based at least in part on received wireless data.

16. The tintable window of claim 15, wherein the transparent display comprises an organic light emitting diode display.

17. A tintable window, the tintable window comprising:
at least one lite, the at least one lite having a first surface facing a first environment, and a second surface facing a second environment;
an electrochromic device coating disposed on the first surface or the second surface of the at least one lite;
a transmitter configured to transmit wireless data via infrared, visible, or ultraviolet light fidelity LiFi signals; and
one or more controllers comprising logic for (a) controlling a tint state of the electrochromic device coating, and (b) controlling the wireless data transmitted by the transmitter.

18. A tintable window, the tintable window comprising:
at least one lite, the at least one lite having a first surface facing a first environment, and a second surface facing a second environment;
an electrochromic device coating disposed on the first surface or the second surface of the at least one lite;
one or more controllers comprising logic for controlling a tint state of the electrochromic device coating; and
a shielding layer on the at least one lite between the first surface and the second surface, wherein the shielding layer is configured to attenuate or block RF and/or LiFi signals from being transmitted between the first surface and the second surface.

19. A building comprising:
a plurality of tintable windows, wherein each window has an electrochromic device coating;
a plurality of controllers configured to control the electrochromic device coatings on the plurality of tintable windows; and
a network connecting the plurality of controllers, the network comprising:
a plurality of receivers configured to receive wireless data transmitted via infrared, visible, or ultraviolet light fidelity (LiFi) signals; and
a plurality of transmitters configured to transmit wireless data via infrared, visible, or ultraviolet LiFi signals.

20. The building of claim 19, wherein at least one of the plurality of tintable windows has a shielding layer configured to block or attenuate radio frequency (RF) and/or LiFi signals from passing through the at least one tintable window.

21. The building of claim 19 or 20, wherein the network connecting the plurality of controllers is a mesh network.

22. The building of any of claims 19 through 21, wherein the plurality of controllers are configured to receive instructions via LiFi signals provided over the network for controlling the plurality of tintable windows.

23. The building of any of claims 19 through 22, wherein the network connecting the plurality of controllers further comprises receivers for receiving radio frequency (RF) signals.

24. The building of any of claims 19 through 23, wherein the network connecting the plurality of controllers further comprises transmitters for transmitting radio frequency (RF) signals.

25. The building of any of claims 19 through 24, wherein the network is further configured to send and/or receive data from mobile devices within or near a building via the plurality of receivers and transmitters.

26. The building of any of claims 19 through 25, wherein the network is connected to the internet.

27. The building of any of claims 19 through 26, wherein the network is configured to communicate to a second mesh network located in a second building via one or more LiFi transmitters facing the second building and one or more LiFi receivers facing the second building.

28. The building of any of claims 19 through 27, wherein the network further comprises firewall logic configured to regulate data transmitted via LiFi signals.

29. The building of claim 20, wherein the shielding layer on the at least one tintable window can be adjusted between a state that blocks or attenuates RF and/or LiFi signals and a state that permits RF and/or LiFi signals to pass through the at least one tintable window.

30. The building of claim 20, wherein the at least one tintable window having a shielding layer is configured to prevent RF and/or LiFi signals from leaving and/or entering the building.

31. A controller for controlling electrochromic windows between an interior and an exterior of a building, wherein the controller configured to:
receive infrared, visible, or ultraviolet wireless light fidelity signals comprising instructions for controlling an optical state of at least one electrochromic window; and
control the optical state of one or more electrochromic windows based on the instructions in the received infrared, visible, or ultraviolet wireless light fidelity signals.

32. The controller of claim 31, wherein the controller is further configured to transmit infrared, visible, or ultraviolet wireless light fidelity signals.

33. The controller of claim 32, wherein the controller comprises a diode laser configured to transmit the infrared, visible, or ultraviolet wireless light fidelity signals.

34. The controller of any of claims 31 through 33, wherein the controller is configured to transmit infrared, visible, or ultraviolet wireless light fidelity signals with status information for the at least one electrochromic window.

35. The controller of claim 34, wherein the status information comprises efficiency data or cycling data for the at least one electrochromic window.

36. The controller of any of claims 31 through 35, wherein the controller is configured to transmit infrared, visible, or ultraviolet wireless light fidelity signals to a window controller and/or a building management system (BMS).

37. The controller of any of claims 31 through 36, wherein the controller is configured to receive infrared, visible, or ultraviolet wireless light fidelity signals via a fiber optic cable.

38. The controller of any of claims 31 through 37, wherein the controller is configured to receive infrared, visible, or ultraviolet wireless light fidelity signals transmitted through free space.

39. The controller of any of claims 31 through 38, wherein the controller is a window controller comprising a microcontroller configured to send information by light fidelity signals.

40. A system for controlling optically switchable windows on a network, wherein each of the optically switchable windows is between an interior and an exterior of a building, the system comprising:
a first controller configured to transmit light fidelity signals comprising instructions for controlling the optical state of at least one optically switchable window; and
a second controller configured to receive the transmitted light fidelity signals and control the optical state of the at least one optically switchable window based on the transmitted instructions.

41. The system of claim 40, wherein the light fidelity signals comprise visible light.

42. The system of claim 40 or 41, wherein the light fidelity signals comprise infrared or near-ultraviolet light.

43. The system of any of claims 40 through 42, wherein the first controller comprises a light-emitting diode (LED) for transmitting the light fidelity signals.

44. The system of claim 43, wherein the LED may be controlled by a user to provide visible lighting in the building.

45. The system of claim 43, wherein the LED comprises a perovskite material.

46. The system of claim 43, wherein the LED comprises cesium lead bromide.

47. The system of claim 40 or 41, wherein the second controller has a photodetector configured to receive the transmitted light fidelity signals.

48. The system of any of claims 40 through 47, wherein the second controller is further configured to transmit additional light fidelity signals comprising status information for the at least one electrochromic window, and wherein the first controller is further configured to receive the additional light fidelity signals transmitted by the second controller.

49. The system of claim 48, wherein the status information to comprises efficiency data or cycling data for the at least one optically switchable window.

50. The system of claim 48 or 49, wherein the second controller is configured to transmit the additional light fidelity signals to a building management system (BMS).

51. A system that defines an interior and an exterior, the system comprising:
a plurality of tintable windows disposed between the interior and the exterior, wherein each window comprises an interior facing pane and at least one exterior facing pane, and wherein at least one of the panes has an electrochromic device coating disposed thereon; and
at least one controller configured to control a tint of the electrochromic device coating on at least one of the plurality of tintable windows so as to selectively form a shielding layer configured to attenuate or block infrared or visible light from passing through at least one of the panes of the at least one of the plurality of tintable windows, wherein the infrared or visible light is from an artificial source.

52. The system of claim 51, further comprising at least one detector functionally coupled to the at least one controller, wherein
the controller is configured to control the tint of at least one of the plurality of tintable windows, in response to detection of the artificial light by the at least one detector.

53. The system of claim 51 or 52, wherein the coating is disposed on the at least one exterior facing pane of the window.

54. The system of any of claims 51 through 53, wherein the coating is disposed on an interior facing side of the at least one exterior facing pane.

55. The system of any of claims 51 through 54, wherein the light is generated by a LiFi device.

56. The system of any of claims 51 through 55, wherein the light is generated by a laser.

57. A method of controlling the passage of light through a tintable window comprising:
controlling a tint of the tintable window with a controller to block transmission of visible or infrared light from passing through at least one of the pane of the tintable window wherein the infrared or visible light is from an artificial source.

58. The method of claim 57, wherein the window comprises an electrochromic coating disposed on at least one pane of the window.

59. The method of claim 58, wherein the window is part of a building, and wherein the electrochromic coating is disposed on an exterior facing pane of the window.

60. The method of claim 59, wherein the electrochromic coating is disposed on an interior facing side of the exterior facing pane.

61. The method of any of claims 57 through 60, wherein the light is generated by a LiFi device.

62. The method of any of claims 57 through 61, wherein the light is generated by a laser.

63. The method of any of claims 57 through 62, further comprising a step of detecting the presence of the light with a detector and in response to detection of the artificial light by the detector controlling the tint of the window with the controller.
